(19) United States
(12) Patent Application Publication
(10) Pub. No.: US 2022/0337711 A1
(43) Pub. Date: Oct. 20, 2022

(54) IMAGING APPARATUS, INFORMATION PROCESSING METHOD, AND PROGRAM

(71) Applicant: Sony Group Corporation, Tokyo (JP)

(72) Inventor: Seigo Kikuchi, Tokyo (JP)

(21) Appl. No.: 17/763,093

(22) PCT Filed: Sep. 10, 2020
(86) PCT No.: PCT/JP2020/034265

§ 371 Date: Mar. 23, 2022

(30) Foreign Application Priority Data
Sep. 30, 2019 (JP) 2019-179412

(51) Int. Cl. H04N 1/00; H04L 67/06

(52) U.S. Cl. CPC H04N 1/00228; H04N 1/00244; H04L 67/06

(57) ABSTRACT

An information processing device, an image processing method and a computer readable medium storing program code for information processing are discloses. In one example, an information processing device comprises a controller configured to transmit a file group including an image file and a related file associated with the image file, and perform second transmission processing to transmit the image file in a case where first transmission processing to transmit the related file is completed.

### CROSS REFERENCE TO RELATED APPLICATIONS

This application claims the benefit of Japanese Priority Patent Application JP 2019-179412 filed Sep. 30, 2019, the entire contents of which are incorporated herein by reference.

### TECHNICAL FIELD

The present technology relates to an imaging apparatus, an information processing method, and a program and, in particular, to a technology to manage the transmission statuses of a captured image and a related file linked with the captured image.

### BACKGROUND ART

Users such as professional photographers and reporters who use imaging apparatuses (also called “cameras”) for work purposes upload images captured by the imaging apparatuses to the servers (file transfer protocol (FTP) servers) of newspaper publishing companies or the like by using the communication functions of the imaging apparatuses in scenes (for example, Patent Literature 1).

Further, newspaper publishing companies or the like could receive an enormous amount of image data since the image data is uploaded by a plurality of users. In the newspaper publishing companies or the like, it is necessary to efficiently search for objective image data or grasp the situations or subjects of transmitted image data.

In order to respond to such a demand, users sometimes link image data with various related files in imaging apparatuses.

In newspaper publishing companies or the like, it becomes possible to grasp transmitted image data and efficiently advance the following editing or selecting operation through the confirmation of related files linked with image data.

### CITATION LIST

### Patent Literature

PTL 1: Japanese Patent Application Laid-open No. 2017-138777

### SUMMARY

### Technical Problem

However, if related files linked with image files become large in amount, there is a need to manage result information regarding transmission processing for each of the files. As a result, management may be complicated. Further, a storage area for storing management information may be increased.

Accordingly, the present technology has been made to efficiently manage result information regarding processing to transmit an image file and a related file linked with the image file.

### Solution to Problem

An imaging apparatus according to the present technology includes: a transmission control unit that, for transmitting a file group including one image file and a related file associated with the one image file, performs second transmission processing to transmit the one image file in a case where first transmission processing to transmit the related file is normally completed.

That is, the transmission of an image file is not performed in a case where the transmission of a related file fails.

The above-mentioned imaging apparatus may further include a status management unit that stores second result information regarding the second transmission processing without storing first result information regarding the first transmission processing.

Thus, compared with a case where the results of both the first transmission processing and the second transmission processing are managed, the amount of managed statuses is reduced.

The status management unit in the above-mentioned imaging apparatus may store information showing transmission failure as the second result information in a case where the second transmission processing is not performed as a result of failure of the first transmission processing.

That is, even in a case where the transmission of an image file is not performed, the same status as that of a case where the transmission of the image file fails is set.

In a case where the related file associated with the one image file includes a plurality of related files, the transmission control unit in the above-mentioned imaging apparatus may perform the second transmission processing with respect to the one image file after performing the first transmission processing with respect to the plurality of related files.

Thus, an image file is transmitted at last.

The transmission control unit in the above-mentioned imaging apparatus may be capable of performing re-transmission processing in a case where the second result information shows failure, and perform both the first transmission processing with respect to the related file and the second transmission processing with respect to the one image file in the re-transmission processing.

Thus, both a related file and an image file are transmitted in the re-transmission processing.

In the above-mentioned imaging apparatus, the image file may include RAW data. An image file that is a transmitted target may be selectable, and RAW data may be provided as one of alternatives.

In the above-mentioned imaging apparatus, the image file may include an image file other than RAW data.

An image file that is a transmitted target may be selectable, and a file format such as JPEG and TIFF other than RAW data may be provided as one of alternatives.

In the above-mentioned imaging apparatus, the related file may include a file associated with the one image file when an image is captured.

For example, a related file includes a text file or the like generated to be linked with a captured image when the image is captured.

In the above-mentioned imaging apparatus, the related file may include a file associated with the one image file when an image is reproduced.

For example, a related file includes a sound memo input when an image is reproduced, a text file obtained by converting the sound memo into a text form, or the like.

In the above-mentioned imaging apparatus, the related file may include an image file of a thumbnail image of the image file.

For example, a thumbnail image generated after an image is captured is a related linked with an image file.

In the above-mentioned imaging apparatus, the related file may include a sound file.

Further, a sound file generated as a sound memo or the like is also handled as a related file.

In the above-mentioned imaging apparatus, the related file may include a text file.

In addition, a text file obtained by converting a sound memo into a text form or the like is also a related file.

In the above-mentioned imaging apparatus, a file name of the image file and a file name of the related file may be different from each other only in an extension.

That is, the comparison of the character strings of portions excluding the extensions of file names makes it possible to determine whether or not the files are associated with each other.

In an information processing method according to the present technology, an information processing apparatus performs: first transmission processing to transmit a related file associated with one image file; and second transmission processing to transmit the one image file, the second transmission processing being performed in a case where the first transmission processing succeeds.

A program according to the present technology causes an information processing apparatus to perform: first transmission processing to transmit a related file associated with one image file; and second transmission processing to transmit the one image file, the second transmission processing being performed in a case where the first transmission processing succeeds.

Thus, it is possible to efficiently manage result information regarding processing to transmit an image file and a related file linked with the image file.

### BRIEF DESCRIPTION OF DRAWINGS

FIG. 1 is a view describing the transfer and upload of an image file and a sound file according to an embodiment of the present technology.

FIG. 2 is a perspective view of an imaging apparatus according to the embodiment.

FIG. 3 is a back view of the imaging apparatus according to the embodiment,

FIG. 4 is a block diagram of the imaging apparatus that performs communication in the embodiment.

FIG. 5 is a view describing the function configuration of a camera control unit according to the embodiment.

FIG. 6 is a view describing an image list screen according to the embodiment.

FIG. 7 is a view describing an image-group pre-development display screen according to the embodiment.

FIG. 8 is a view describing an image-group post-development display screen according to the embodiment.

FIG. 9 is a view describing the image-group post-development display screen according to the embodiment.

FIG. 10 is a view describing a sound memo recording screen according to the embodiment.

FIG. 11 is a view describing the image-group post-development display screen according to the embodiment.

FIG. 12 is a view describing the image-group pre-development display screen according to the embodiment.

FIG. 13 is a view describing the image-group pre-development display screen according to the embodiment.

FIG. 14 is a view describing a sound memo reproduction screen according to the embodiment.

FIG. 15 is a view describing a modified example of the sound memo reproduction screen according to the embodiment.

FIG. 16 is a view describing a deletion-target selection screen according to the embodiment.

FIG. 17 is a view describing a deletion-in-process screen according to the embodiment.

FIG. 18 is a view describing a deletion completion screen according to the embodiment.

FIG. 19 is a view describing a deletion selection screen according to the embodiment.

FIG. 20 is a view describing the deletion selection screen according to the embodiment.

FIG. 21 is a view describing a first example of the flow of a file transfer according to the embodiment.

FIG. 22 is a view describing a second example of the flow of the file transfer according to the embodiment.

FIG. 23 is a view describing a third example of the flow of the file transfer according to the embodiment.

FIG. 24 is a view describing a fourth example of the flow of the file transfer according to the embodiment.

FIG. 25 is a view describing a fifth example of the flow of the file transfer according to the embodiment.

FIG. 26 is a flowchart of image reproduction operation detection processing according to the embodiment.

FIG. 27 is a flowchart of the image reproduction operation detection processing according to the embodiment.

FIG. 28 is a flowchart of the image reproduction operation detection processing according to the embodiment.

FIG. 29 is a flowchart of assignable button operation detection processing according to the embodiment.

FIG. 30 is a flowchart of transfer processing according to the embodiment.

### DESCRIPTION OF EMBODIMENTS

Hereinafter, an embodiment will be described in the following order.

<1. Image Upload by Imaging Apparatus>

<2. Configuration of imaging Apparatus>

<3. Function Configuration of Imaging Apparatus>

<4. User Interface Screen>

<5. FTP Transfer>

<6. Processing Flow>

<6-1. Image Reproduction Operation Detection Processing>

<6-2. Assignable Button Operation Detection Processing>

<6-3. Transfer Processing>

<7. Summary>

<8. Present Technology>

<1. Image Upload by Imaging Apparatus>

An imaging apparatus 1 according to an embodiment is capable of uploading a captured image to an external server. First, this image upload will be described.

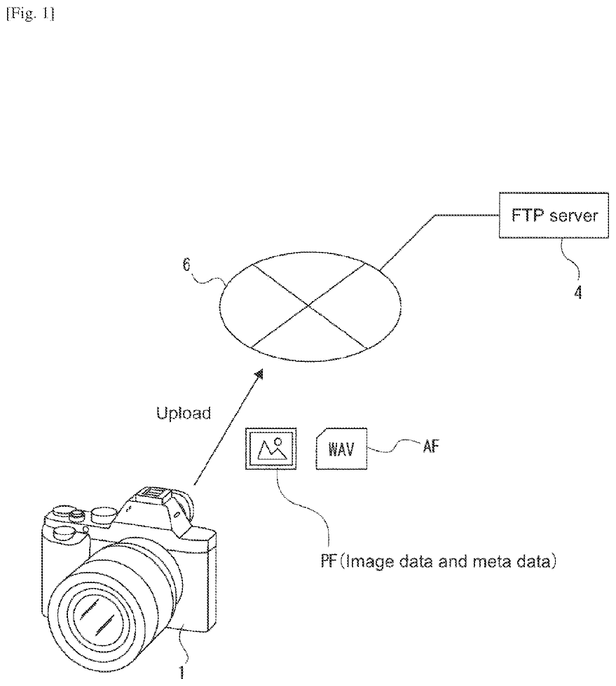

In FIG. 1, the imaging apparatus 1, a FTP server 4, and a network 6 are shown.

The imaging apparatus 1 includes imaging apparatuses in various forms such as video cameras and still cameras. As the imaging apparatus 1 shown in the figure, a camera used by a photographer or a reporter in sites, covering scenes, or the like of sports or events is assumed. For example, one photographer may use one imaging apparatus 1 or a plurality of imaging apparatuses 1 according to circumstances.

Note that the imaging apparatus 1 will be sometimes called a “camera” in the description.

As the network 6, any of the Internet, a home network, a local area network (LAN), a satellite communication network, and various other networks is, for example, assumed.

As the FTP server 4, a server managed by a newspaper publishing company, a broadcasting station, a news agency, or the like is, for example, assumed. Of course, the FTP server 4 is not limited to such a server.

As the form of the FTP server 4, a cloud server, a home server, a personal computer, or the like is assumed.

The imaging apparatus 1 is capable of uploading captured image data or the like to the FTP server 4 via the network 6.

For example, when a user using the imaging apparatus 1 is a professional photographer who works for a newspaper publishing company, he/she is assumed to use a system to immediately upload an image captured at an event site from the imaging apparatus 1 to the FTP server 4. Alternatively, with a mobile terminal apparatus such as a smart phone possessed by the user assumed as the FTP server 4, image data or the like may be uploaded to the mobile terminal apparatus serving as the FTP server 4 via the network 6 such as near field communication.

On this occasion, FTP setting information for performing an upload to the FTP server 4 is registered in the imaging apparatus 1. The content of the FTP setting information includes the host name of the FTP server 4, a storage destination path, a user name, a password, a connection type, or the like.

By performing an input operation on the imaging apparatus 1 to input such content of the FTP setting information, the user is allowed to register the FTP setting information in the imaging apparatus 1. Alternatively, the content of the FTP setting information may be transferred from external equipment to register the FTP setting information in the imaging apparatus 1.

In the embodiment, a situation in which a related file is uploaded and transmitted from the imaging apparatus 1 to the FTP server 4 together with an image file PF is assumed. The imaging apparatus 1 is capable of generating a related file linked with a captured image file PF. The related file is assumed to include various files such as text files, sound files, and thumbnail image files. Note that thumbnail images may be contained in the image file PF as metadata.

The imaging apparatus 1 is equipped with a sound memo function. The sound memo function is a function with which the user is allowed to add sound comments, sound descriptions, or the like to a captured image. For example, when the user produces a sound while performing a prescribed operation with a specific image designated or when a photographer produces a sound to describe image content while performing a prescribed operation at the time of capturing a still image, the sound is recorded and a sound memo associated with image data is generated.

FIG. 1 shows an example in which a sound file AF is uploaded and transmitted as a related file together with an image file PF. That is, the sound file AF is a file generated as a file different from the image file PF.

Note that although a surrounding sound is also recorded as sound track data at the time of capturing a moving image, the sound track data is sound data contained in the image file PF and different from the sound file AF. The descriptive sound file AF refers to a file containing sound data as a sound memo.

The following description assumes an example in which a still image is captured, the image file PF contains still image data and metadata, and the sound file AF contains sound memo data generated as the still image is captured.

Note that all the image files PF are not necessarily associated with the sound file AF. The sound file AF is generated and associated with the image file PF in the imaging apparatus 1 only when a photographer or the like performs a sound input using the sound memo function.

Accordingly, when the imaging apparatus 1 performs an upload to the FTP server 4, the image file PP may be transmitted together with the sound file AF or may be transmitted alone.

Of course, a related file different from the sound file AF may be uploaded and transmitted together with the image file PF.

Note that the imaging apparatus 1 generates image data as a still image or a moving image through its imaging operation and generates metadata as additional information.

As the image file PF shown in FIG. 1, a data file containing image data and metadata accompanying the image data is assumed.

<2. Configuration of Imaging Apparatus>

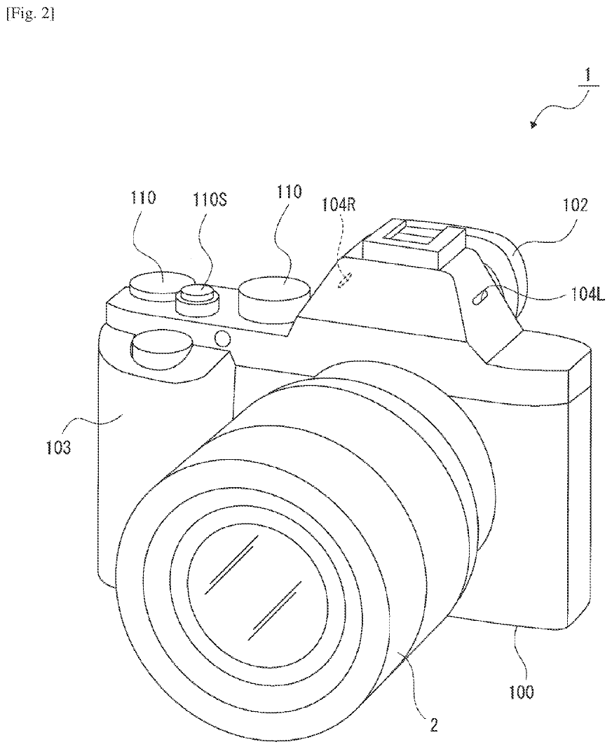

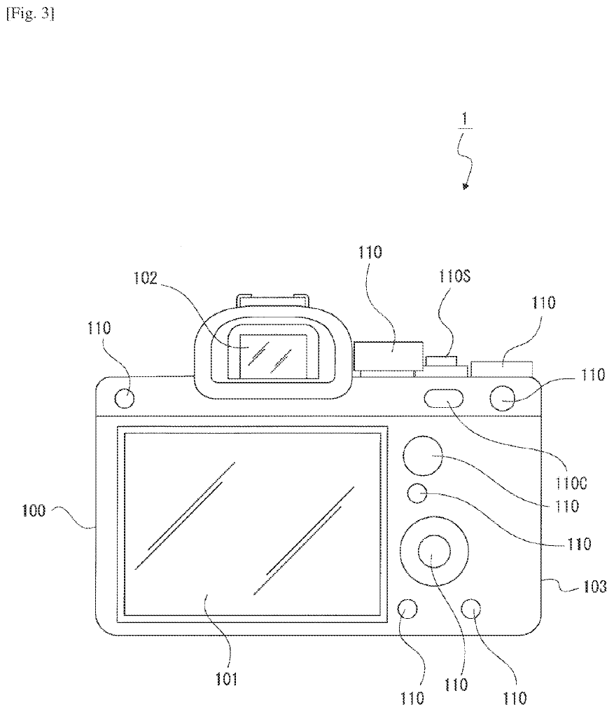

FIG. 2 is a perspective view of the imaging apparatus 1 according to the embodiment as seen from its front side. FIG. 3 is a back view of the imaging apparatus 1. Here, it is assumed that the imaging apparatus 1 is so-called a digital still camera and capable of capturing both a still image and a moving image through the switching of an imaging mode.

Note that in the embodiment, the imaging apparatus 1 is not limited to a digital still camera but may be a video camera that is mainly used for capturing a moving image and is also capable of capturing a still image.

In the imaging apparatus 1, a lens barrel 2 is arranged or detachable on the front side of a body housing 100 constituting a camera body.

On the back side (photographer side) of the imaging apparatus 1, a display panel 101 formed by a display device such as a liquid crystal display (LCD) and an organic electro-luminescence (EL) display is, for example, provided.

Further, a display unit formed by a LCD, an organic EL display, or the like is also provided as a viewfinder 102. Further, the viewfinder 102 is not limited to an electronic viewfinder (EVE) but may be an optical viewfinder (OVF).

The user is allowed to visually recognize an image or various information through the display panel 101 or the viewfinder 102.

In this example, both the display panel 101 and the viewfinder 102 are provided in the imaging apparatus 1. However, the imaging apparatus 1 may have a configuration in which one of the display panel 101 and the viewfinder 102 is provided or have a configuration in which both or one of the display panel 101 and the viewfinder 102 is detachable.

On the body housing 100 of the imaging apparatus 1, various operation elements 110 are provided.

For example, as the operation elements 110, operation elements in various forms such as keys, a dial, and press/rotation-combined operation elements are arranged and realize various operation functions. With the operation elements 110, the user is allowed to perform, for example, a menu operation, a reproduction operation, a mode selection operation, a focus operation, a zoom operation, an operation to select a parameter such as a shutter speed and an F-number, or the like. The detailed description of each of the operation elements 110 will be omitted. However, in the present embodiment, a shutter button 110S and an assignable button 1100 among the operation elements 110 are particularly shown.

The shutter button 110S is used for performing a shutter operation (release operation) or an AF operation based on a half press.

The assignable button 110C is an operation element also called a custom button and is a button to which the user is allowed to assign any operation function. In the present embodiment, it is assumed that the function of operating the recording, reproduction, or the like of a sound memo is assigned to the assignable button 110C. That is, the user is allowed to perform the recording, reproduction, or the like of a sound memo by operating the assignable button 1100 under a specific situation. For example, by pressing the assignable button 110C for a long time under a specific situation, the user is allowed to record a sound memo during the pressing. The recording of a sound memo is stopped when the user cancels the long-press of the assignable button 110C. Further, a recorded sound memo is reproduced when the user presses the assignable button 1100 for a short time.

The shutter button 110S is arranged on an upper surface on the right side of the body housing 100 and capable of being pressed and operated by the forefinger of a right hand in a state in which the user holds a holding part 103 with his/her right hand.

Further, the assignable button 1100 is arranged at an upper part on the back side of the body housing 100 as shown in, for example, FIG. 3 and capable of being pressed and operated by the thumb of the right hand of the user.

Note that a dedicated operation button for performing a function related to a sound memo may be provided instead of the assignable button 110C.

Further, in a case where a display unit such as the display panel 101 has a touch panel function, the display panel 101 may serve as one of the operation elements 110.

On both lateral sides of the viewfinder 102, microphone holes 104 are formed. A microphone hole 104 on the left side as seen from the photographer is a microphone hole 104L, and a microphone hole 104 on the right side as seen from the photographer is a microphone hole 1048.

With the formation of the microphone hole 104L and the microphone hole 104R, the imaging apparatus 1 is capable of acquiring an environment sound or a sound produced by the photographer as a stereo sound. In each of the microphone holes 104, a microphone not shown is disposed.

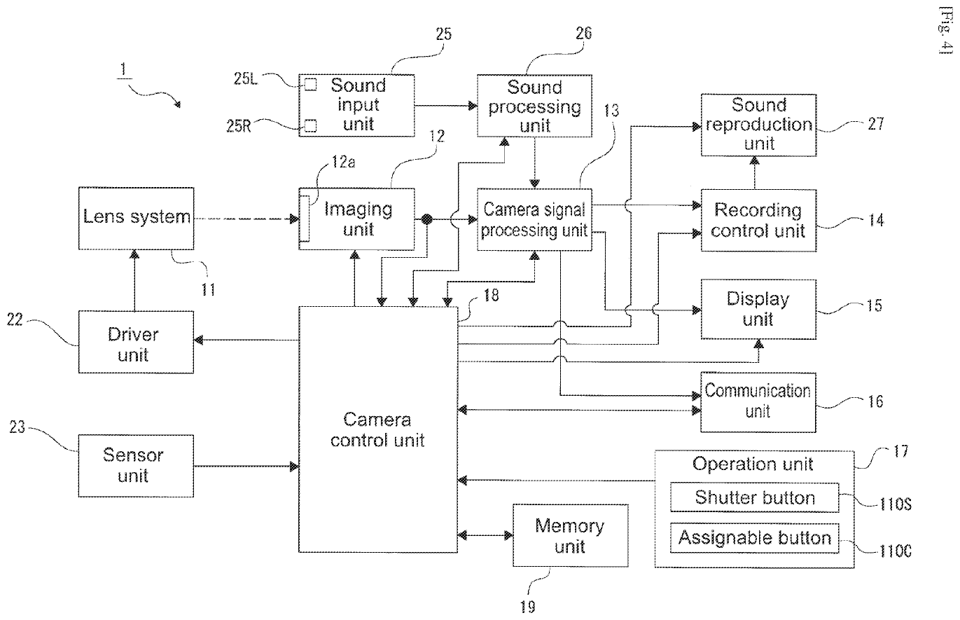

FIG. 4 shows the internal configuration of the imaging apparatus 1 including the lens barrel 2.

The imaging apparatus 1 has, for example, a lens system 11, an imaging unit 12, a camera signal processing unit 13, a recording control unit 14, a display unit 15, a communication unit 16, an operation unit 17, a camera control unit 18, a memory unit 19, a driver unit 22, a sensor unit 23, a sound input unit 25, a sound processing unit 26, and a sound reproduction unit 27.

The lens system 11 includes a lens such as a zoom lens and a focus lens, an aperture mechanism, or the like. By the lens system 11, light (incident light) from an object is introduced and condensed into the imaging unit 12.

The imaging unit 12 is configured to have, for example, an image sensor 12a (imaging element) such as a complementary metal-oxide semiconductor (CMOS) type and a charge-coupled device (CCD) type.

The imaging unit 12 applies, for example, correlated double sampling (CDS) processing, automatic gain control (AGC) processing, or the like to an electric signal obtained by photoelectrically converting light received by the image sensor 12a, and further applies analog/digital (A/D) conversion processing to the signal. Then, the imaging unit 12 outputs an imaging signal to the subsequent camera signal processing unit 13 or the camera control unit 18 as digital data.

The camera signal processing unit 13 is constituted as an image processing processor by, for example, a digital signal processor (DSP) or the like. The camera signal processing unit 13 applies various signal processing to a digital signal (captured image signal) from the imaging unit 1:2. The camera signal processing unit 13 performs, for example, pre-processing, synchronization processing, YC generation processing, resolution conversion processing, file formation processing, or the like as a camera process.

In the pre-processing, the camera signal processing unit 13 performs clamp processing to clamp the black level of R, G, and B at a prescribed level, correction processing between the color channels of R, G, and B, or the like on a captured image signal from the imaging unit 12.

In the synchronization processing, the camera signal processing unit 13 applies color separation processing to cause image data on each pixel to have all color components of R, G, and B. For example, with an imaging element using the color filter of a Bayer array, the camera signal processing unit 13 applies demosaic processing as color separation processing.

In the YC generation processing, the camera signal processing unit 13 generates (separates) a brightness (Y) signal and a color (C) signal from the image data of R, G, and B.

In the resolution conversion processing, the camera signal processing unit 13 applies resolution conversion processing to image data to which various signal processing has been applied.

In the file formation processing, the camera signal processing unit 13 performs, for example, compressing coding for recording or communication, formatting, generation or addition of metadata, or the like on, for example, image data to which the above-mentioned various processing has been applied to generate a file for recording or communication.

The camera signal processing unit 13 generates an image file PF in a format such as a joint photographic experts group (JPEG), a tagged image file format (TIFF), and a graphics interchange format (GIF) as, for example, a still image file. Further, it is also assumed that the camera signal processing unit 13 generates an image file PF in an MP4 format or the like used for recording a moving image and a sound based on MPGE-4.

Note that the camera signal processing unit 13 is also assumed to generate an image file PF as a RAW file (RAW image data).

The camera signal processing unit 13 generates metadata as data containing information regarding processing parameters inside the camera signal processing unit. 13, various control parameters acquired from the camera control unit 18, information showing the operation state of the lens system 11 or the imaging unit 12, mode setting information, and imaging environment information (such as the date and time and a place).

The recording control unit 14 performs recording and reproduction on, for example, a recording medium constituted by a non-volatile memory. The recording control unit 14 performs processing to record an image file of moving-image data, still-image data, or the like, a thumbnail image, or the like on, for example, a recording medium.

The actual form of the recording control unit 14 is assumed in various ways. For example, the recording control unit 14 may be constituted as a flash memory and its writing/reading circuit included in the imaging apparatus 1. Further, the recording control unit 14 may be a recording medium detachable from the imaging apparatus 1, for example, a form of a card recording reproduction unit that accesses a memory card (such as a portable flash memory) to perform recording and reproduction. Further, the recording control unit 14 may be realized as a hard disk drive (HDD) or the like that is a form included in the imaging apparatus 1.

The display unit 15 is a display unit that performs various displays for the photographer and is, for example, the display panel 101 or the viewfinder 102 constituted by a display device such as a LCD panel and an EL display arranged in the housing of the imaging apparatus 1.

The display unit 15 causes various information to be displayed on a display screen on the basis of an instruction from the camera control unit 18.

For example, the display unit 15 causes a reproduction image of image data read from a recording medium in the recording control unit 14 to be displayed.

Further, after receiving image data of a captured image of which the resolution has been converted to perform a display by the camera signal processing unit 13, the display unit 15 may perform a display on the basis of the image data of the captured image according to an instruction from the camera control unit 18. Thus, a so-called through-image (a monitoring image of an object) that is a captured image during the confirmation of a composition, the recording of a moving image, or the like is displayed.

Further, the display unit 15 causes various operation menus, icons, messages, or the like, that is, information representing a graphical user interface (GUI) to be displayed on the screen according to an instruction from the camera control unit 18.

The communication unit 16 performs data communication or network communication with external equipment in a wired or wireless fashion.

The communication unit 16 transmits and outputs captured image data (a still-image file or a moving-image file) to, for example, an external display apparatus, a recording apparatus, a reproduction apparatus, or the like.

Further, the communication unit 16 is capable of performing communication via various networks 6 such as the Internet, a home network, and a LAN as a network communication unit and transmitting and receiving various data to/from servers, terminals, or the like on the networks. In the present embodiment, for example, the communication unit 16 performs communication processing to upload captured image data (such as the above-mentioned image files) to the FIT server 4.

Further, in the present embodiment, the communication unit 16 performs communication with an information processing apparatus to transfer an image file PF or a sound file AF.

An input device operated by the user to perform various operation inputs is collectively shown as the operation unit 17. Specifically, the operation unit 17 shows various operation elements (such as keys, a dial, a touch panel, and a touch pad) provided in the housing of the imaging apparatus 1.

The operation unit 17 detects an operation by the user and transmits a signal corresponding to the input operation to the camera control unit 18.

As the operation unit 17, the shutter button 110S or the assignable button 1100 described above is provided.

The camera control unit 18 is constituted by a microcomputer (processor) including a central processing unit (CPU).

The memory unit 19 stores information or the like used by the camera control unit 18 to perform processing. In the figure, a read-only memory (ROM), a random access memory (RAM), a flash memory, or the like is collectively shown as the memory unit 19.

The memory unit 19 may be a memory area included in a microcomputer chip serving as the camera control unit 18, or may be constituted by a separate memory chip.

The camera control unit 18 performs a program stored in the ROM, the flash memory, or the like of the memory unit 19 to control the entire imaging apparatus 1.

The camera control unit 18 controls the operations of necessary respective units with respect to, for example, the control of a shutter speed of the imaging unit 12, instructions to perform various signal processing in the camera signal processing unit 13, an imaging operation or a recording operation according to the operation of the user, the operation of reproducing a recorded image file, the operation of the lens system 11 such as zooming, focusing, and aperture adjustment in the lens barrel, the operation of a user interface, or the like.

The camera control unit 18 according to the present embodiment controls the communication unit 16 to perform the transmission control of an image file PP or a sound file AF serving as a related file, processing to manage result information regarding processing to transmit an image file PF as a status, or the like.

The RAM in the memory unit 19 is used for temporarily storing data, a program, or the like as a working area used when the CPU of the camera control unit 18 processes various data.

The ROM or the flash memory (non-volatile memory) in the memory unit 19 is used for storing an application program for various operations, firmware, various setting information, or the like, besides an operating system (OS) used by the CPU to control respective units and a content file such as an image file.

The various setting information includes the above-mentioned FTP setting information, exposure setting serving as setting information regarding an imaging operation, shutter speed setting, mode setting, white balance setting serving as setting information regarding image processing, color setting, setting on image effect, custom key setting or display setting serving as setting information regarding operability, or the like.

In the driver unit 2:2, a motor driver for a zoom-lens driving motor, a motor driver for a focus-lens driving motor, a motor driver for an aperture-mechanism motor, or the like is, for example, provided.

These motor drivers apply a driving current to a corresponding driver according to an instruction from the camera control unit 18 to perform the movement of a focus lens or a zoom lens, the opening/closing of an aperture blade of an aperture mechanism, or the like.

Various sensors installed in the imaging apparatus 1 are collectively shown as the sensor unit 23.

An inertial measurement unit (IMU) is, for example, installed as the sensor unit 23. The sensor unit 23 is capable of detecting an angular speed with, for example, the angular speed (gyro) sensor of the three axes of a pitch, a yaw, and a roll and detecting acceleration with an acceleration sensor.

Further, a position information sensor, an illumination sensor, or the like is, for example, installed as the sensor unit 23.

The sound input unit 25 has, for example, a microphone, a microphone amplifier, or the like and outputs a sound signal in which a surrounding sound is collected. In the present embodiment, the microphone 25L corresponding to the microphone hole 104L and the microphone 25R corresponding to the microphone hole 104R are provided as microphones.

The sound processing unit 26 performs processing to convert a sound signal obtained by the sound input unit 25 into a digital sound signal, AGC processing, sound quality processing, noise reduction processing, or the like. Sound data that has been subjected to these processing is output to the camera signal processing unit 13 or the camera control unit 18.

For example, sound data is processed as sound data accompanying a moving image by the camera control unit 18 when the moving image is captured.

Further, sound data serving as a sound memo input by the photographer during reproduction, imaging, or the like is converted into a sound file AF by the camera signal processing unit 13 or the camera control unit 18.

A sound file AF may be recorded on a recording medium to be associated with an image file PF by the recording control unit 14, or may be transmitted and output from the communication unit 16 together with an image file PF.

The sound reproduction unit 27 includes a sound signal processing circuit, a power amplifier, a speaker, or the like and performs the reproduction of a sound file AF that has been recorded on a recording medium by the recording control unit 14. When a sound file AF is, for example, reproduced, the sound data of the sound file AF is read by the recording control unit 14 on the basis of the control of the camera control unit. 18 and transferred to the sound reproduction unit 27. The sound reproduction unit 27 performs necessary signal processing on the sound data or converts the sound data into an analog signal and outputs a sound from the speaker via the power amplifier. Thus, the user is allowed to hear a sound recorded as a sound memo.

Note that when a moving image is reproduced, a sound accompanying the moving image is reproduced by the sound reproduction unit 27.

<3. Function Configuration of Imaging Apparatus>

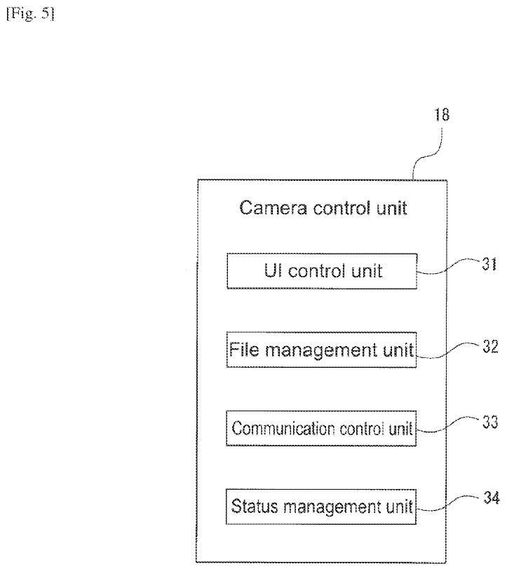

In the imaging apparatus 1, a function configuration as shown in FIG. 5 is constructed when a program stored in a ROM or a RAM serving as the memory unit 19 is performed.

The imaging apparatus 1 includes a user interface (UI) control unit 31, a file management unit 32, a communication control unit 33, and a status management unit 34.

The control unit 31 performs processing to detect operations that have been performed on the various operation elements 110 included in the imaging apparatus 1, display processing using the display unit 15, processing to output a sound, processing to present an input operation environment to the user, or the like.

Specifically, the UI control unit 31 performs processing to present an environment allowing an input operation to the user via a display output or a sound output. Further, the UI control unit 31 performs a display output or a sound output to present various information to the user.

In addition, when the operation elements 110 are operated by the user, the UI control unit 31 detects the operation and performs processing corresponding to the operation.

In particular, in the embodiment, the UI control unit 31 detects a situation in which the assignable button 1100 has been pressed under a specific condition, and performs processing to record a sound memo as corresponding processing.

Further, the UI control unit 31 performs processing to present a U environment to reproduce a sound memo, a UT environment to delete a sound memo, or the like.

The file management unit 32 performs processing to store a captured image that has been captured by the user as an image file PF, processing to store a sound memo that has been input by the user as a sound file AF, or the like. Besides, the file management unit 32 performs processing to store a related file linked with an image file PF.

When storing an image file PF or a sound file AF, the file management unit 32 performs processing to add a file name to each file. The file name of an image file PF is, for example, one in which an extension for an image is added to a counter value showing the number of images (still images or moving images) that have been captured since a reset. Further, the file name of a sound file AF serving as a sound memo is one in which an extension for a sound file AF is added to the same counter value as that of an image file to which the sound memo corresponds. Moreover, the file name of a related file associated with an image file PF is one different from the file name of the image file PF only in an extension. According to such naming rule of a file name, a related file such as a sound file AF is associated with an image file PF.

In the following description, the character string of a portion excluding an extension in a file name will be described as a “base name.”

Further, the file management unit 32 performs processing to delete an image file PF and a sound file AF designated by the user.

In addition, the file management unit 32 performs processing to acquire an image file PF or a sound file AF designated to be reproduced from the memory unit 19.

The communication control unit 33 is a function used for controlling the communication operation of the communication unit 16.

The communication control unit 33 performs processing to cause the communication unit 16 to perform communication with the FTP server 4.

Specifically, the communication control unit 33 performs upload processing to the FTP server 4 via the communication unit 16.

The communication control unit 33 performs processing to upload an image file PF and a sound file AF generated by the file management unit 32 as a pair to the FTP server 4.

Note that the order of transmitting files is a characteristic of the present embodiment. As will be specifically described later, processing to transmit an image file PF is performed after processing to transmit a related file such as a sound file AF.

The status management unit 34 sets and manages a transmission status for each image file PF in a manner that depends on whether or not processing to transmit the image file PF has been normally completed. The status management unit 34 performs processing to store a transmission status for each image file PF or processing to acquire the transmission status of a designated image file PP.

<4. User Interface Screen>

A UI screen in the display panel 101 of the imaging apparatus 1 will be described. In particular, a display example related to a continuously-shot image and a sound memo will be mainly described. Note that each screen in the following description is an example of a screen displayed on the display panel 101 serving as the display unit 15 when the camera control unit 18 of the imaging apparatus 1 performs a function as the control unit 31.

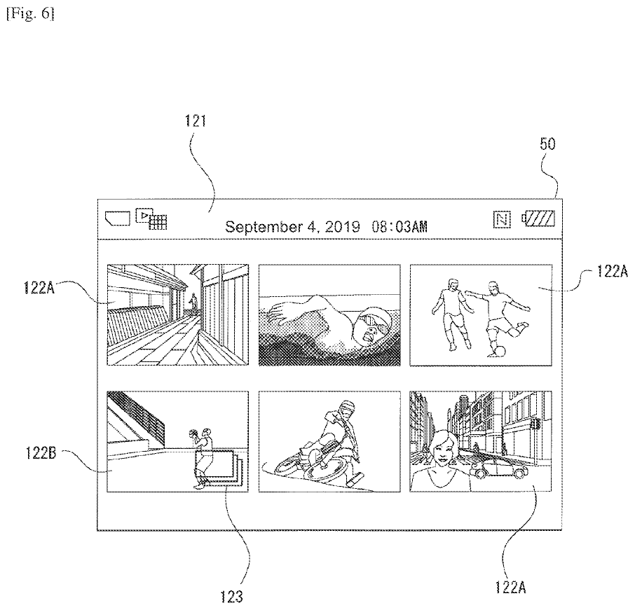

FIG. 6 shows an image list screen 50 through which the user is allowed to visually recognize images (still images or moving images) captured by the imaging apparatus 1 in list form.

The image list screen 50 is, for example, a screen displayed on the display panel 101 in a reproduction mode.

In the image list screen 50, a status bar 121 in which an indicator showing time information or a battery charged state or the like is displayed and thumbnail images 122 corresponding to a plurality of captured images are displayed.

As the thumbnail images 122, any of thumbnail images 122A each showing one image captured in a single-shooting mode and thumbnail images 122B each showing an image group in which a plurality of images captured in a continuous-shooting mode is put together are displayed.

In the thumbnail images 122B each showing an image group, one of a plurality of images contained in the image groups is selected as a representative image. A captured image used for the thumbnail images 122B may be selected by the user or may be automatically selected.

For example, the image captured at first among a plurality of images captured in the continuous-shooting mode is automatically selected as a representative image and used for the thumbnail images 122B.

In the thumbnail images 122B each showing an image group, an image group icon 123 showing an image group is displayed so as to overlap.

A plurality of images captured in the continuous-shooting mode may be automatically put together and generated as an image group, or a plurality of images selected by the user may be generated as an image group.

When any of the thumbnail images 122 is selected and operated in the image list screen 50, the display of the display panel 101 is switched to a next screen.

For example, when a thumbnail image 122A showing an image captured in the single-shooting mode is selected, the display is switched to a screen in which the selected image is largely displayed.

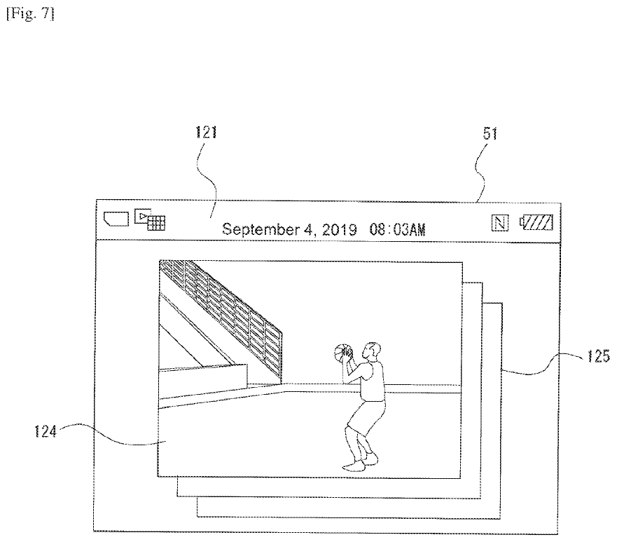

Further, when a thumbnail image 122B showing an image group is selected, the display is switched to a screen in which the selected image group is displayed (see FIG. 7).

A screen shown in FIG. 7 is a screen that is dedicated to an image group in which a plurality of images is displayed without being developed, and that is called an image-group pre-development display screen 51.

In the image-group pre-development display screen 51, a representative image 124 and a frame image 125 showing a state in which a plurality of images is contained in an image group are displayed.

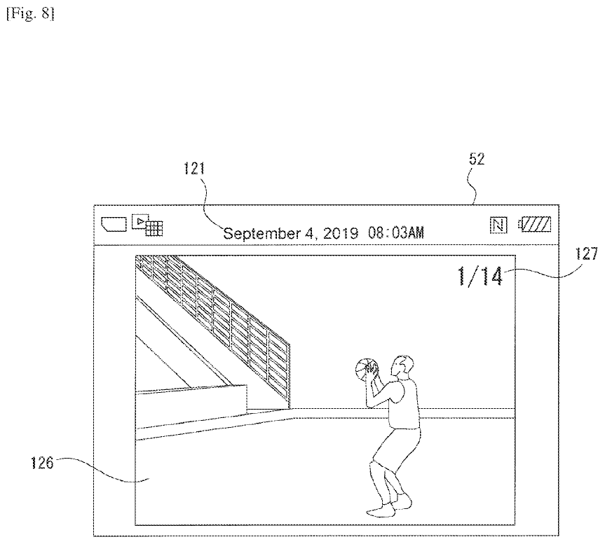

When the representative image 124 or the like in the image-group pre-development display screen 51 is operated, an image-group post-development display screen shown in FIG. 8 is displayed on the display panel 101.

In the image-group post-development display screen 52, one of the plurality of images belonging to the image group is selected and displayed. In FIG. 8, the image captured at first among a series of image groups captured in the continuous-shooting mode is displayed as a display image 126.

Further, in the image-group post-development display screen 52, a count display 127 showing the total number of the images belonging to the image group and the order of the displayed image is displayed. The count display 127 in FIG. 8 shows a state in which the first image in the image group including 14 images is being displayed.

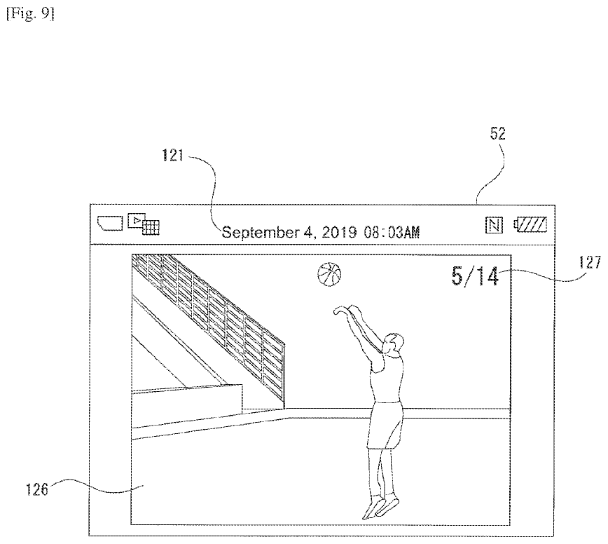

In the image-group post-development display screen 52, it is possible to perform an image feeding operation through a swipe operation or a button operation. The image feeding operation is an operation to change the display image 126 to another image. FIG. 9 shows the image-group post-development display screen 52 displayed after the image feeding operation has been performed a plurality of times.

FIG. 9 shows a state in which the fifth image among the 14 images belonging to the image group has been displayed.

When the assignable button 110C is pressed for a long time from the state shown in FIG. 9, the recording of a sound memo is started. The recording of the sound memo is completed in a case where the long-pressed state of the assignable button 110C is cancelled or in a case where the recording time of the sound memo reaches a prescribed time.

Further, the sound memo is stored to be linked with the display image 126 displayed on the display panel 101 when the assignable button 110C is pressed for a long time. In this example, the assignable button 110C is pressed for a long time from the state shown in FIG. 9. Therefore, the sound memo is linked with the fifth image of the image group.

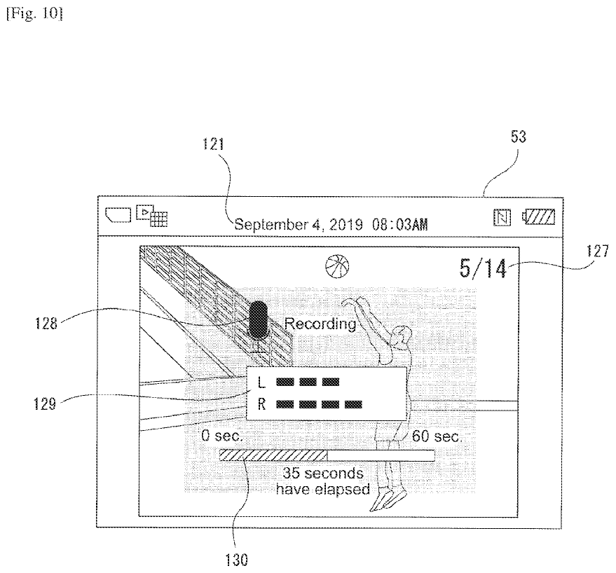

During the recording of the sound memo, a sound memo recording screen 53 shown in FIG. 10 is displayed on the display panel 101.

In the sound memo recording screen 53, a recording icon 128 showing a state in which the sound memo is being recorded, a recording level gauge 129 showing the respective input levels of the microphone 25L and the microphone 25R, and a recording time bar 130 showing a recording time and a remaining recording time are displayed.

In an example shown in FIG. 10, a maximum recording time is set at 60 seconds, and the sound memo has been recorded for 35 seconds.

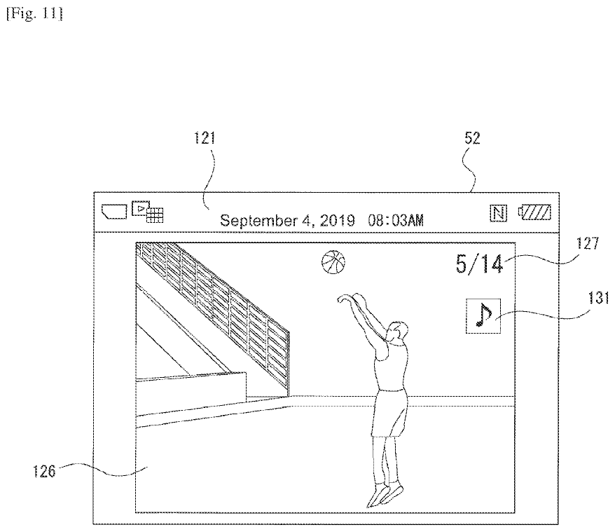

After the recording of the sound memo for 60 seconds is completed or after the long-pressed state of the assignable button 110C is cancelled before the elapse of the maximum recording time, the image-group post-development display image 52 shown in FIG. 11 is displayed on the display panel 101. FIG. 11 shows a state in which the fifth image among the 14 images belonging to the image group is displayed like FIG. 9. Further, a sound memo icon 131 showing a state in which the image is associated with the sound memo is displayed so as to overlap the image.

When an operation to cancel the developed display of the image group such as the press of a return button is performed from the state shown in FIG. 11, the image-group pre-development display screen 51 shown in FIG. 7 is displayed on the display panel 101. The image group shown in FIG. 7 is put in a state in which the sound memo corresponding to the fifth image has been recorded. However, since the representative image 124 displayed on the display panel 101 is the first image belonging to the image group and no sound memo exists in the first image, the sound memo icon 131 is not displayed.

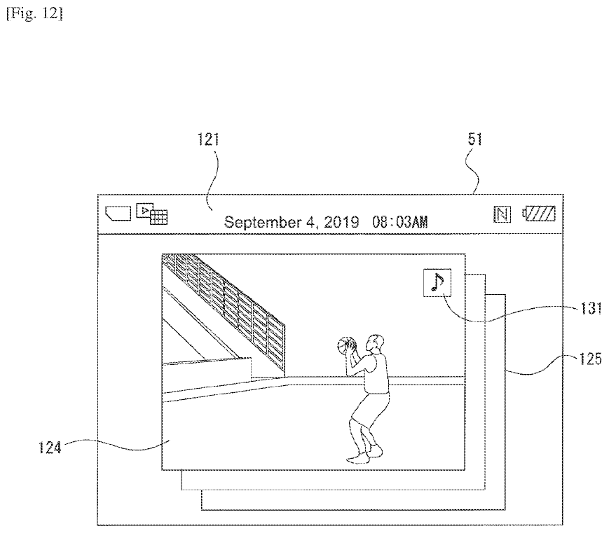

Note that in a case where a sound memo has been recorded for the representative image 124, the sound memo icon 131 is displayed in the image-group pre-development display screen 51 as shown in FIG. 12.

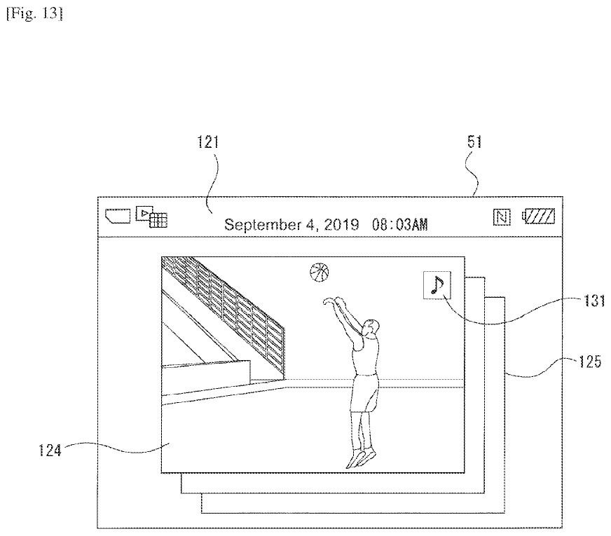

Modified examples of the image-group pre-development display image 51 displayed when the developed display is cancelled after the fifth image is associated with the sound memo will be described with reference to FIGS. 12 and 13.

In the above description, the sound memo icon 131 is displayed in the image-group pre-development display screen 51 as shown in FIG. 12 in a case where the sound memo corresponding to the representative image 124 has been recorded. In a modified example, no sound memo exists in the first image selected as the representative image 124, but at least one image (for example, the fifth image) among the images belonging to the image group is associated with a sound memo. Therefore, in order to show a state in which the image belonging to the image group contains the sound memo, the sound memo icon 131 may be displayed as shown in FIG. 12.

Thus, the user is allowed to recognize the presence or absence of an image in which a corresponding sound memo exists through the sound memo icon 131 without performing the developed display of the image group.

Further, in a modified example shown in FIG. 13, one of images (for example, the fifth image) in which a corresponding sound memo exists among the images belonging to the image group is newly selected as the representative image 124.

That is, the user is allowed to recognize, only by visually recognizing the image-group pre-development display screen 51 shown in FIG. 13, a state in which a corresponding sound memo exists in any of the images of the image group and at least one of the images in which the sound memo exists is an image selected as the representative image 124.

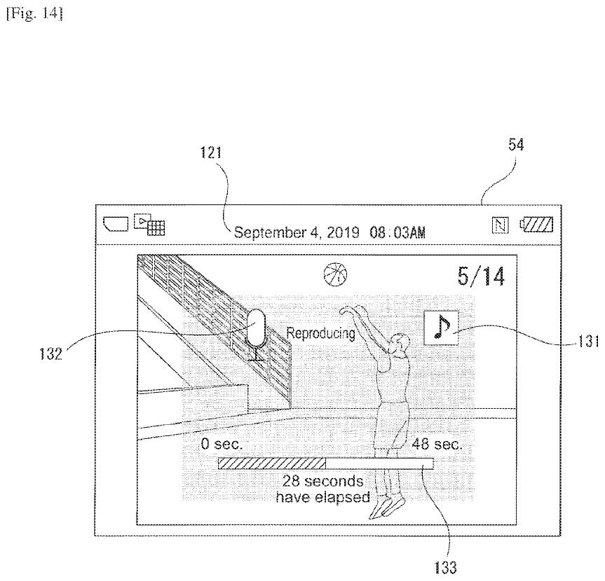

Meanwhile, in a case where an operation to reproduce a sound memo such as the short-press of the assignable button 1100 is performed in, for example, the image-group post-development display screen 52 shown in FIG. 11, that is, in the image-group post-development display screen 52 in which the image where the sound memo exists is displayed as the display image 126, a sound memo reproduction screen shown in FIG. 14 is displayed on the display panel 101.

In the sound memo reproduction screen 54, the sound memo icon 131, a reproduction icon 132 showing a state in which the sound memo is being reproduced, and a reproduction time bar 133 showing the recording time of the sound memo and an elapsed reproduction time are displayed on the image linked with the sound memo that is a reproduced target.

The reproduction icon 13:2 is, for example, an icon image that is the same in shape and different in color from the recording icon 128 shown in FIG. 10.

In an example shown in FIG. 14, the recording time of the sound memo is 48 seconds, and the segment of the sound memo at 27 seconds since the start of the reproduction is being reproduced.

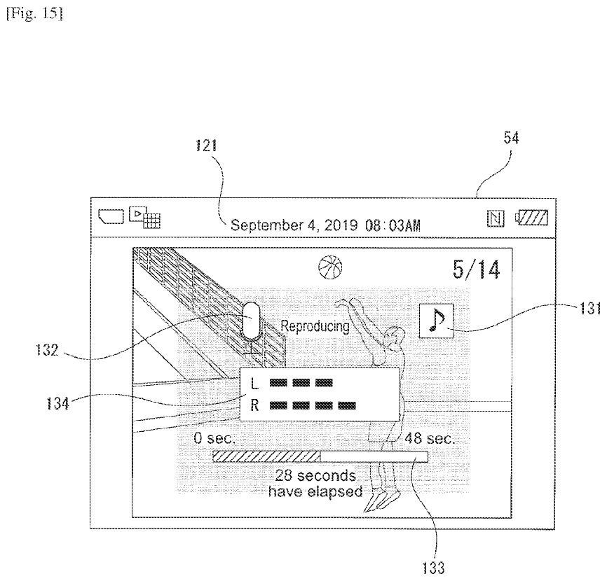

A modified example of the sound memo reproduction screen 54 is shown in FIG. 15.

In the sound memo reproduction screen 54 shown in FIG. 15, a reproduction level gauge 134 showing the reproduction levels of a left channel and a right channel is displayed, besides the sound memo icon 131, the reproduction icon 132, and the reproduction time bar 133.

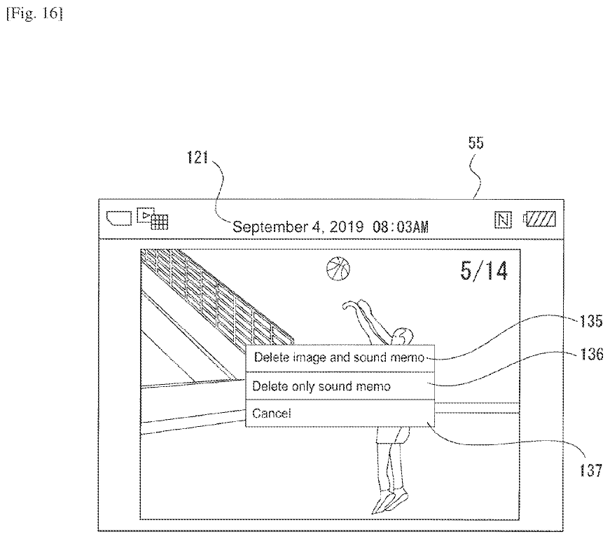

When an operation to perform the deletion or the like of the sound memo is performed in the image-group post-development display screen 52 shown in FIG. 11, that is, in the image-group post-development display screen 52 in which the image where the corresponding sound memo exists is displayed as the display image 126, a deletion target selection screen 55 shown in FIG. 16 is displayed on the display panel 101.

In the deletion target selection screen 55, three operable alternatives are presented to the user. Specifically, a first alternative 135 for deleting both an image file PF and a sound file AF serving as a sound memo, a second alternative 136 for deleting only the sound file AF serving as a sound memo while leaving the image file PF, and a third alternative 137 for cancelling the deletion operation are displayed.

The image file PF or the sound file AF deleted in a case where any of the first alternative 135 and the second alternative 136 is operated is a file related to the display image 126 displayed on the display panel 101 during the deletion operation.

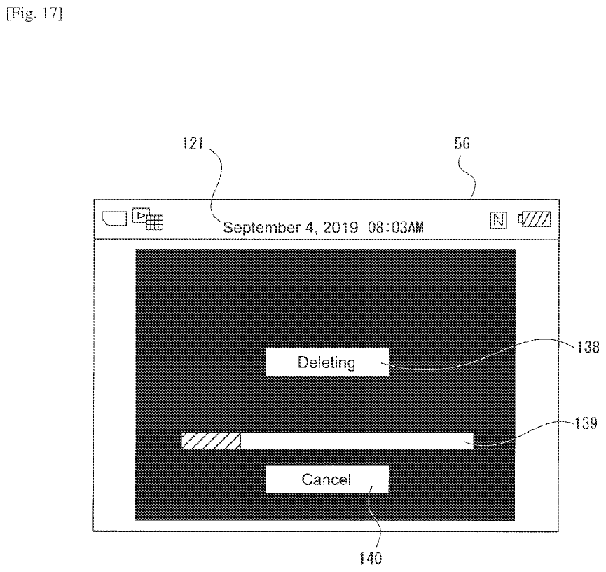

In a case where any of the first alternative 135 and the second alternative 136 is operated, a deletion-in-process screen 56 shown in FIG. 17 is displayed on the display panel 101.

In the deletion-in-process screen 56, a message 138 showing a state in which the deletion of the file is in process, a deletion bar 139 showing the progress of deletion processing, and a cancel button 140 for cancelling the deletion processing are displayed.

When the user operates the cancel button 140 in a state in which the deletion-in-process screen 56 is being displayed, the deletion of the file that is a deleted target is cancelled.

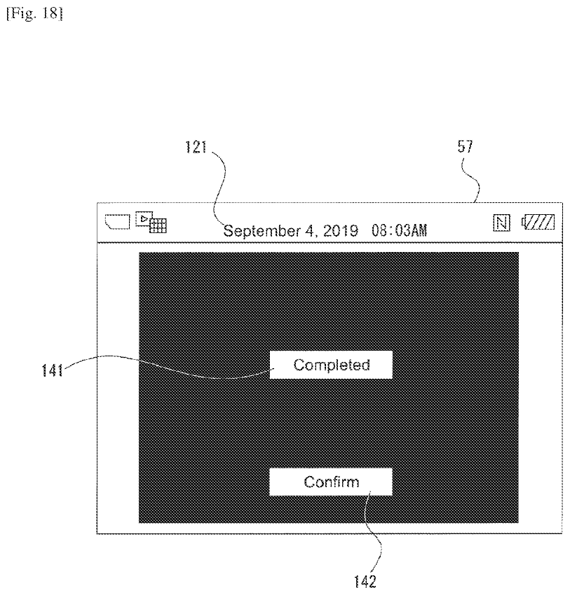

When a file deletion time elapses without the operation of the cancel button 140, a deletion completion screen 57 shown in FIG. 18 is displayed on the display panel 101.

In the deletion completion screen 57, a message 141 showing a state in which the deletion has been completed and a confirmation button 142 operated to confirm the completion of the deletion are displayed.

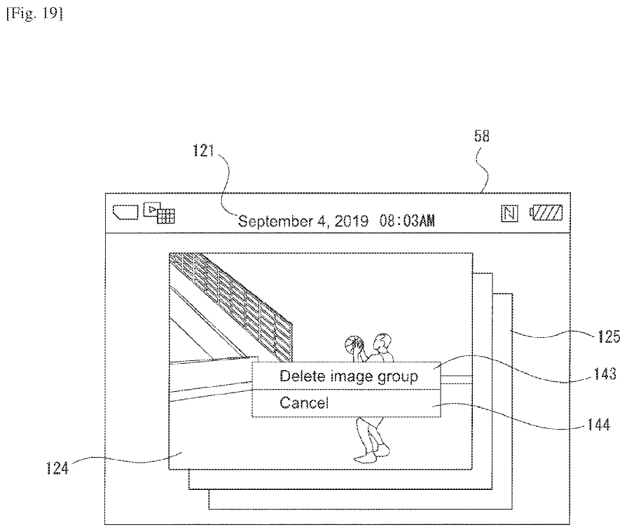

When an operation to perform the deletion or the like is performed in the image-group pre-development display screen 51 shown in FIG. 7, a deletion selection screen 58 shown in FIG. 19 is displayed on the display panel 101.

In the deletion selection screen 58, an all-deletion alternative 143 for deleting all the images belonging to the image group in a lump and a cancel alternative 144 for cancelling the deletion operation are displayed.

Note that when the all-deletion alternative 143 is operated in a case where a sound file AF serving as a sound memo linked with any of the images belonging to the image group exists, not only an image file PF but also the associated sound file AF is assumed to be deleted.

Note that an alternative for deleting only a sound file AF serving as a sound memo linked with any of the images belonging to the image group may be provided.

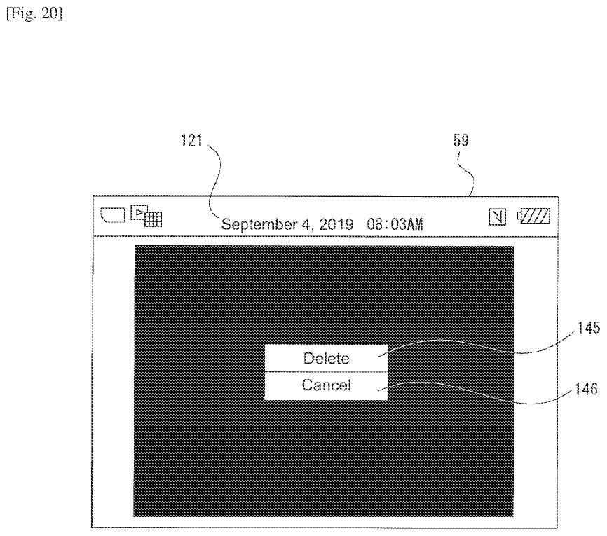

When the deletion operation is performed in a state in which an image not linked with a sound memo is displayed as the display image 1:26 (for example, the state shown in FIG. 8), a deletion selection screen 59 shown in FIG. 20 is displayed on the display panel 101.

In the deletion selection screen 59, a deletion alternative 145 for deleting an image file PF and a cancel alternative 146 for cancelling the deletion operation are displayed.

When the deletion alternative 145 is operated, the deletion of the image is started. As a result, the deletion-in-process screen 56 shown in FIG. 17 is, for example, displayed.

Further, when the cancel alternative 146 is operated, the deletion operation is cancelled. As a result, the display returns to a screen (for example, the screen shown in FIG. 8) before the cancel operation.

<5. FTP Transfer>

As described above, an image file PF and a related file such as a sound file AF are transferred (transmitted) by the control of the communication control unit 33 of the camera control unit 18. Specifically, the UI control unit 31 detects an operation to perform FTP transfer or an operation to select an image file PF that is a target for the FTP transfer, and the communication control unit 33 issues an instruction to the communication unit 16 in response to the detection. As a result, a designated image file PP or a sound file AF serving as a related file are transferred to the FTP server 4.

Note that in the following description, image data and its related file group will be called “one file group.” The one file group may contain a plurality of image files PP and a plurality of related files. The plurality of image files PF refers to, for example, types having different file formats such as RAW files and REG files and refers to files obtained in a single imaging operation. Further, the plurality of related files refers to sound files AF described above, text files, thumbnail files, or the like and includes files generated during an imaging operation, files generated during a reproduction operation, or the like.

By, for example, selecting one image captured in a single-shooting mode from the image list screen 50 in which a plurality of images is displayed, the user is allowed to select one file group related to the one image as a target for FTP transfer. At this time, the number of transferred image files PP is not limited to one. That is, there is a case where even one image captured in a single-shooting mode is linked with a plurality of image files. For example, in a case where one image is selected and instructed to be subjected to FTP transfer, the two files of a RAW file and a REG file having the same base name (for example, “0001”) may be transferred.

By selecting a plurality of images, the user is also allowed to designate a plurality of file groups to perform. FTP transfer. In this case, a related file and an image file PF are transferred for each of the file groups.

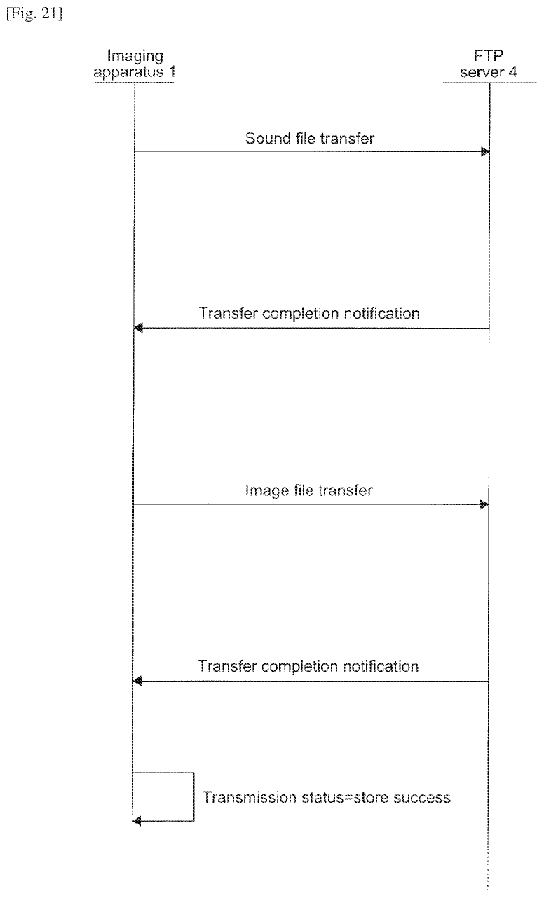

The flow of processing performed in a case where an image file PF or a related file is transferred from the imaging apparatus 1 to the FTP server 4 will be described with reference to each of FIGS. 21 to 25.

A first example shown in FIG. 21 is an example of a case where one image file PP and one related file (sound file AF) are transferred to the FTP server 4.

First, the imaging apparatus 1 that has detected an operation to start FTP transfer by the user performs processing to transfer a sound file AF to the FIT server 4.

In a case where the transfer of the sound file AF is completed, a transfer completion notification notifying that the transfer has been normally completed is transmitted from the FTP server 4 to the imaging apparatus 1.

The imaging apparatus 1 that has received the transfer completion notification about the sound file AF next performs processing to transfer an image file PF.

In a case where the transfer of the image file PF is completed, a transfer completion notification notifying that the transfer has been normally completed is transmitted from the FTP server 4 to the imaging apparatus 1.

When receiving the transfer completion notification about the image file PF, the imaging apparatus 1 sets (stores) data (such as a flag)) showing “success” in the transfer status of one image, that is, in the transfer status of the image file PF about one file group.

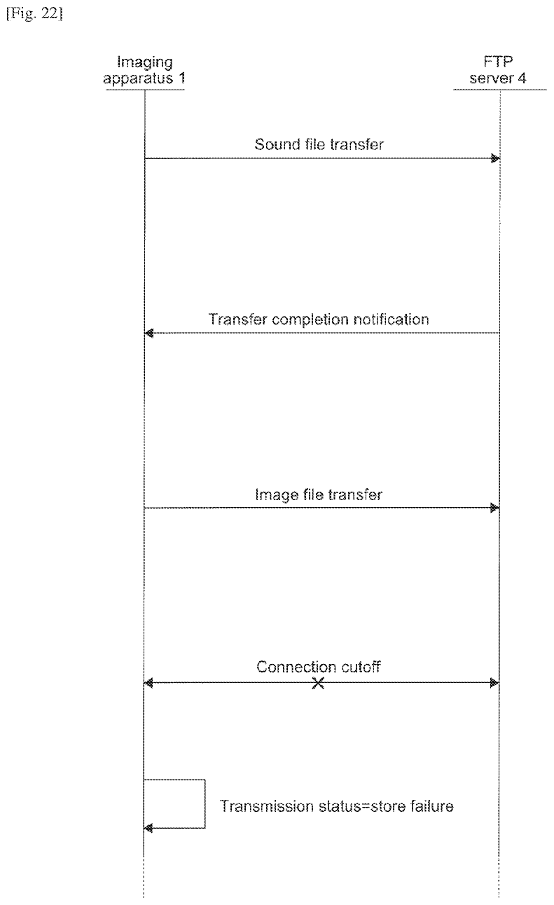

A second example shown in FIG. 22 is an example of a case where processing to transfer an image file PF fails.

The imaging apparatus 1 that has detected an operation to start FTP transfer by the user performs processing to transfer a sound file AF to the FTP server 4.

In a case where the transfer of the sound file AF is completed, a transfer completion notification notifying that the transfer has been normally completed is transmitted from the FTP server 4 to the imaging apparatus 1.

The imaging apparatus 1 that has received the transfer completion notification about the sound file AF next performs processing to transfer an image file PF.

When connection is cut off for any reason during the transfer of the image file PF, the occurrence of a timeout is determined after the elapse of a prescribed time. In this case, the imaging apparatus 1 is unable to receive a transfer completion notification until the prescribed time elapses since the start of the FTP transfer. That is, when having not received the transfer completion notification until the prescribed time elapses since the start of the FTP transfer, the imaging apparatus 1 determines the occurrence of a timeout and estimates that the transfer of the image file PF has not been normally completed.

Subsequently, the imaging apparatus 1 sets (stores) “failure” in the transfer status of one image, that is, in the transfer status of the image file PF about one file group.

Note that when a timeout occurs in the transfer processing since a communication hand is not sufficiently secured even if the connection is not cut off, data showing failure may be set in the transfer status of the image file PF.

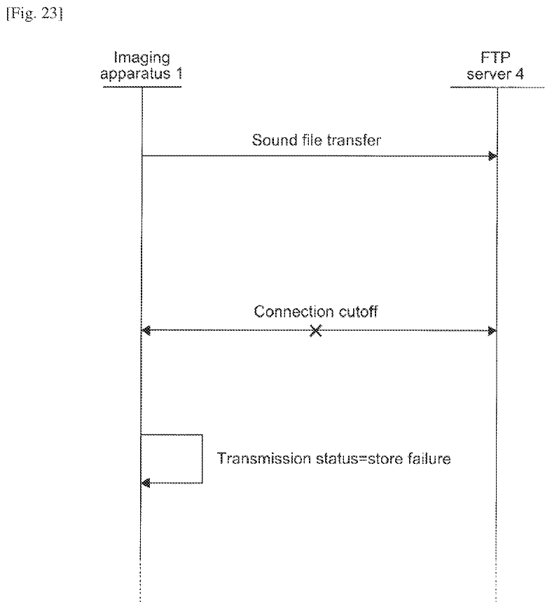

A third example shown in FIG. 23 is an example of a case where processing to transfer a related file fails.

The apparatus 1 that has detected an operation to start FTP transfer by the user performs processing to transfer a sound file AF to the FTP server 4. When having not received a transfer completion notification after a prescribed time elapses since the transfer start of the sound file AF, the imaging apparatus 1 determines the occurrence of a timeout and estimates that the transfer of the related file has not been normally completed.

In this case, an image file PF is not transferred since processing to transfer the image file PF has not been performed. The imaging apparatus 1 manages this state as a state in which the transfer of the image file PF has failed. That is, the imaging apparatus 1 sets data showing the failure of the transfer status of the image file PF.

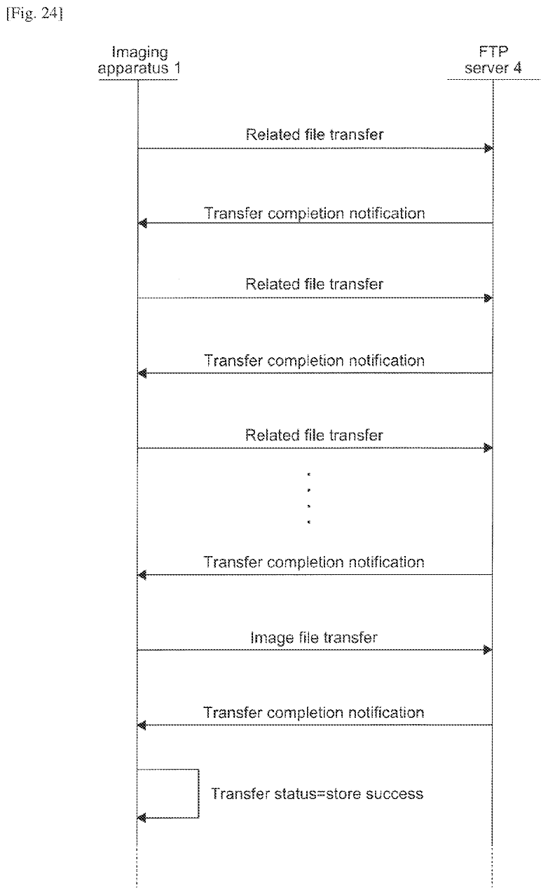

A fourth example shown in FIG. 24 is an example of a case where a plurality of related files is transferred.

The imaging apparatus 1 that has detected an operation to start FTP transfer by the user performs processing to transfer a related file to the FTP server 4.

In a case where the transfer of the related file is completed, a transfer completion notification notifying that the transfer has been normally completed is transmitted from the FTP server 4 to the imaging apparatus 1.

The imaging apparatus 1 performs processing to transfer a related file and processing to receive a transfer completion notification by the number of times corresponding to the number of the related files that are transferred targets.

In a case where the processing to transfer all the related files is normally completed, the imaging apparatus 1 next performs processing to transfer an image file PF.

In a case where the transfer of the image file PP is completed, a transfer completion notification notifying that the transfer has been normally completed is transmitted from the FTP server 4 to the imaging apparatus 1.

When receiving the transfer completion notification about the image file VP, the imaging apparatus 1 sets data showing “success” in the transfer status of one image, that is, in the transfer status of the image file PP about one file group.

Note that in a case where the transfer is not normally completed in any of the file transfer processing shown in FIG. 24, the imaging apparatus 1 sets data showing “failure” in the transfer status of the image file PF about the one file group regardless of whether or not the processing to transfer the image file PF has been performed.

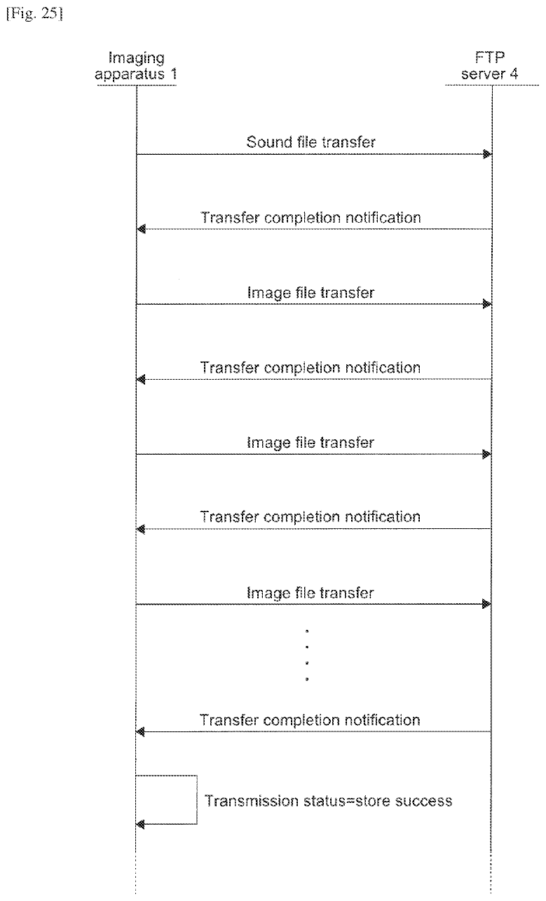

A fifth example shown in FIG. 25 is an example of a case where a plurality of image files PF is transferred.

The imaging apparatus 1 that has detected an operation to start FTP transfer by the user performs processing to transfer a sound file AF to the FTP server 4.

In a case where the transfer of the sound file AF is completed, a transfer completion notification notifying that the transfer has been normally completed is transmitted from the FTP server 4 to the imaging apparatus 1.

The imaging apparatus 1 that has received the transfer completion notification about the sound file AF next performs processing to transfer an image file PF.

In a case where the transfer of the image file PF is completed, a transfer completion notification notifying that the transfer has been normally completed is transmitted from the FTP server 4 to the imaging apparatus 1.

The imaging apparatus 1 performs processing to transfer an image file PF and processing to receive a transfer completion notification by the number of times corresponding to the number of the image files PF that are transferred targets.

In a case where the processing to transfer all the image files PF is normally completed, the imaging apparatus 1 sets data showing “success” in the transfer status of one image, that is, in the transfer status of the image file PF about one file group.

Note that in a case where the transfer is not normally completed in any of the file transfer processing shown in FIG. 25, the imaging apparatus 1 sets data showing “failure” in the transfer status of the image file PF about the one file group regardless of whether or not the processing to transfer the image file PF has been performed.

Note that when transferring a plurality of image files PF and a plurality of related files, the imaging apparatus 1 only has to perform the processing to transfer image files shown in FIG. 25 after performing the processing to transfer related files shown in FIG. 24.

<6. Processing Flow>

<6-1. Image Reproduction Operation Detection Processing>

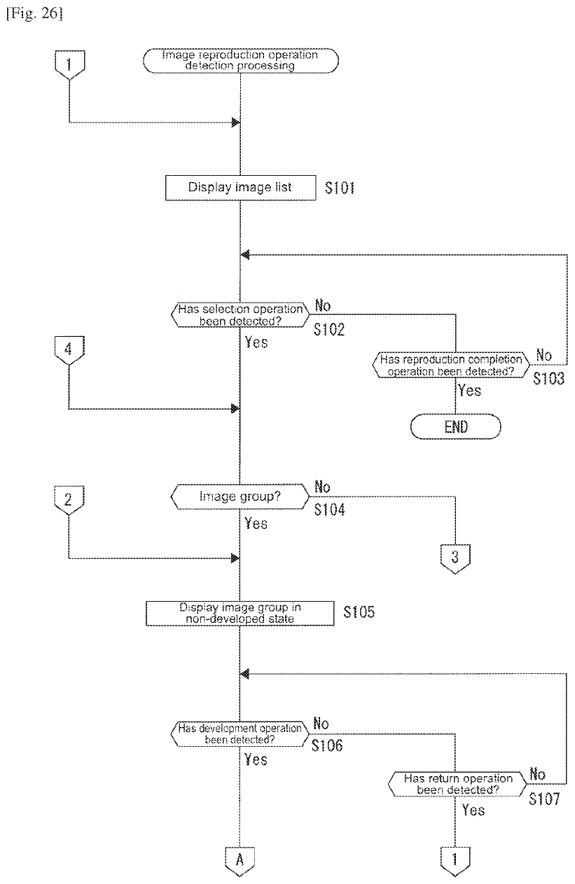

About processing to detect an operation to transition between respective screens or processing to perform a screen transition with respect to the image list screen 50 shown in FIG. 6, the image-group pre-development display screen 51 shown in FIG. 7, or the image-group post-development display screen 52 shown in FIG. 8, processing performed by the camera control unit 18 is shown in FIGS. 26, 27, and 28.

A flowchart shown in each of the figures shows processing performed when an operation to reproduce a captured image is detected and shows image reproduction operation detection processing.

When detecting an image reproduction operation, the camera control unit 18 causes a list of images to be displayed using the image list screen 50 (see FIG. 6) in Step S101 of FIG. 26.

The camera control unit 18 determines in Step S102 whether or not an operation to select one image has been detected in the image list screen 50. In a case where the image selection operation has not been detected, the camera control unit 18 determines in Step S103 whether or not an operation to complete image reproduction has been detected.

In a case where the operation to complete the image reproduction has been detected, the camera control unit 18 completes the image reproduction operation detection processing.

In a case where the operation to complete the image reproduction has not been detected, the camera control unit 18 returns to the processing of Step S102. That is, the camera control unit 18 repeatedly performs the processing of Steps S102 and S103 until the image selection operation is detected or until the reproduction completion operation is detected.

In a case where the operation to select one image (or one image group) has been detected in Step S102, the camera control unit 18 determines in Step S104 whether or not the selected target is an image group.

In a case where the image group has been selected, the camera control unit 18 displays the image-group pre-development display screen 51 (see FIG. 7) to display the image group in a non-developed state in Step S105.

In a state in which the image-group pre-development display screen 51 is displayed, the camera control unit IS determines in Step S106 whether or not a development operation has been detected. In a case where the development operation has not been detected, the camera control unit 18 determines in Step S107 whether or not a return operation to return to a previous screen has been detected.

In a case where the return operation has been detected, the camera control unit 18 returns to Step S101 and causes the image list screen 50 to be displayed to present the previous screen to the user.

In a case where the return operation has not been detected in Step S107, the camera control unit 18 returns to the processing of Step S106. That is, the camera control unit 18 repeatedly performs the processing of Step S106 and the processing of Step S107 until one of the development operation and the return operation is detected.

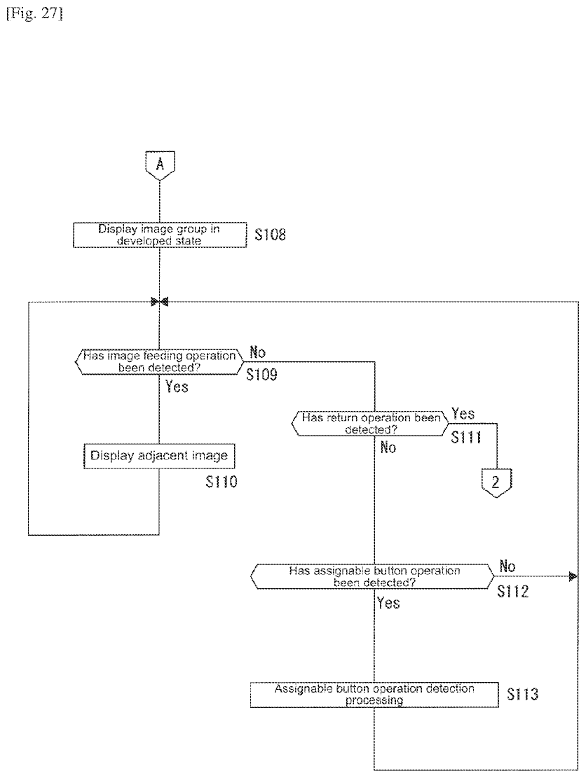

In a case where the development operation has been detected in Step S106, the camera control unit 18 displays the image-group post-development display screen 52 (see FIG. 8) to display the image group in a developed state in Step S108 of FIG. 27.

The camera control unit 18 determines in Step S109 whether or not an image feeding operation such as a swipe operation and the press of a direction key has been detected in the image-group post-development display screen 52. In a case where the image feeding operation has been detected, the camera control unit 18 performs processing to display an adjacent image corresponding to the operation in Step S110. By appropriately detecting the image feeding operation, the camera control unit 18 displays a plurality of images belonging to the image group on the display panel 101 in order.

In a case where the image feeding operation has not been detected in Step S109, the camera control unit 18 determines in Step S111 whether or not a return operation has been detected. In a case where the return operation has been detected, the camera control unit 18 returns to Step S105 and causes the image-group pre-development display screen 51 to be displayed to present the previous screen to the user. Thus, the camera control unit 18 is allowed to switch the display before the development of the image group and the display after the development of the image group to each other.

In a case where the return operation has not been detected in Step S111, the camera control unit 18 determines in Step S112 whether or not an operation with respect to the assignable button 1100 has been detected. Note that in this example, a function related to a sound memo is performed by the operation of the assignable button 1100. Therefore, the operation with respect to the assignable button 1100 has been detected in Step S112. When the function related to the sound memo is assigned to any of the operation elements 110 other than the assignable button 1100, an operation with respect to the operation element 110 to which the function is assigned is detected in Step S112. Further, when the function related to the sound memo is performed by both the assignable button 1100 and any of the operation elements 110, the operations with respect to both the assignable button 110C and the operation element 110 are detected in Step S112.

In a case where the operation with respect to the assignable button 1100 has not, been detected, the camera control unit 18 returns to Step S109. That is, the camera control unit 18 repeatedly performs the detection processing of Steps S109, S111, and S112 until the image feeding operation, the return operation, or the operation with respect to the assignable button 110C is detected.

In a case where the operation with respect to the assignable button 110C has been detected, the camera control unit 18 performs assignable button operation detection processing in Step S113. This processing is processing to perform various functions related to a sound memo according to an operation mode. The processing will be described in detail later.

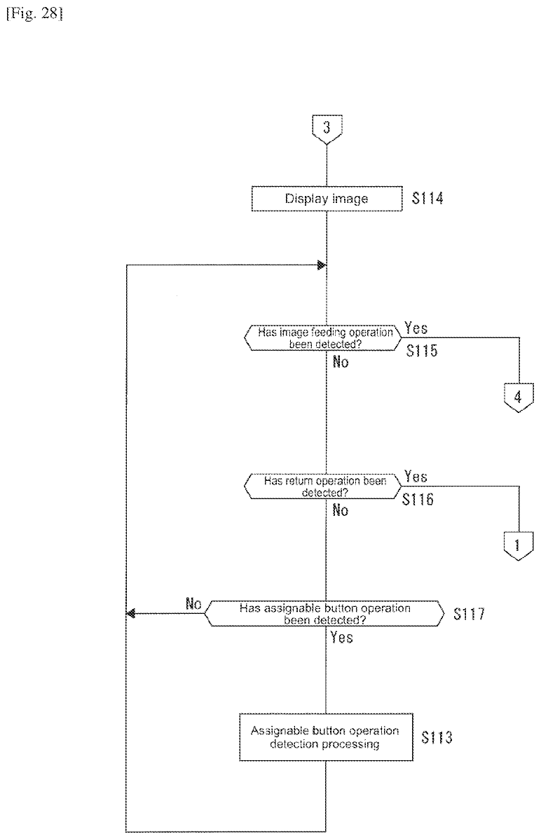

The description will return to the processing of Step S104. The processing of Step S104 is processing to determine whether or not an image selected in the image list screen 50 is an image group. In a case where it is determined in the processing that the selected image is not an image group, that is, in a case where it is determined that one image has been selected, the camera control unit 18 performs processing to display the selected image in Step S114 of FIG. 28.

The camera control unit 18 determines in Step S115 whether or not an image feeding operation has been detected in a screen in which the one image is displayed. In a case where the image feeding operation has been detected, the camera control unit 18 returns to the processing of Step S104. That is, the camera control unit 18 determines whether or not an adjacent image corresponding to the operation is an image group. The camera control unit 18 proceeds to the processing of Step S105 in a case where the image is an image group or proceeds to Step S114 in a case where the image is not an image group but shows one image. Thus, the camera control unit 18 performs appropriate display processing in a manner that depends on whether or not an adjacent image is an image group.

In a case where the image feeding operation has not been detected, the camera control unit 18 determines in Step S116 whether or not a return operation has been detected. In a case where the return operation has been detected, the camera control unit 18 returns to Step S101 and displays the image list screen 50 to present the previous screen to the user. Thus, the camera control unit 18 is allowed to switch the screen in which one image is displayed and the screen in which a list of images are displayed to each other.

In a case where the return button has not been detected, the camera control unit 18 determines in Step S117 whether or not an operation with respect to the assignable button 110C, has been detected. Note that since the function related to a sound memo is assigned to the assignable button 110C as described above, the operation with respect to the assignable button 110C has been detected in Step S117.

In a case where the operation with respect to the assignable button 110C has been detected, the camera control unit 18 performs the assignable button operation detection processing in Step S113. This processing is processing to perform each function related to a sound memo according to an operation mode and will be described in detail later.

In a case where the operation with respect to the assignable button 1100 has not been detected, the camera control unit 18 returns to Step S115. That is, the camera control unit 18 repeatedly performs the detection processing of Steps S115, S116, and S1.17 until the image feeding operation, the return operation, or the operation with respect to the assignable button 110C is detected.

<6-2. Assignable Button Operation Detection Processing>

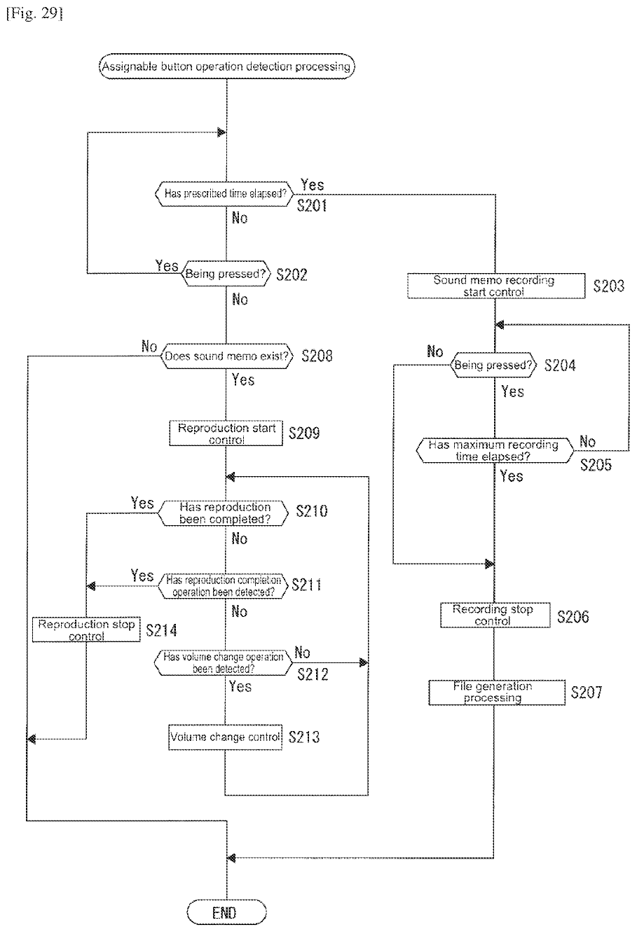

FIG. 29 shows processing performed in a case where an operation with respect to the assignable button 110C serving as an operation element to which a function related to a sound memo is assigned is detected. The processing shown in FIG. 29 is processing performed by each unit (such as the UI control unit 31 and the file management unit 32) of the camera control unit 18.

The camera control unit 18 determines in Step S201 whether or not a prescribed time has elapsed since the press of the assignable button 1100. In a case where the prescribed time has not elapsed, the camera control unit 18 determines in Step S202 whether or not the assignable button 1100 is being pressed.

In a case where the assignable button 110C is being pressed, the camera control unit 18 returns to Step S201 and determines whether or not the prescribed time has elapsed.

That is, in a case where the assignable button 110C is pressed for a long time, the camera control unit 18 repeatedly performs the processing of Step S201 and the processing of Step S202 until the elapse of the prescribed time and proceeds from Step S201 to Step S203 at a point at which the prescribed time has elapsed.

On the other hand, in a case where the pressed state of the assignable button 1100 is cancelled before the elapse of the prescribed time, for example, in a case where the assignable button 110C is pressed for a short time, the camera control unit 18 proceeds from the processing of Step S202 to the processing of Step S208.

That is, processing performed in a case where the assignable button 110C is pressed for a long time is the processing of Step S203 and the processing of the subsequent steps, while processing performed in a case where the assignable button 1100 is pressed for a short time is the processing of Step S208 and the processing of the subsequent steps.

In a case where the assignable button 110C is pressed for a long time, the camera control unit 18 performs control to start recording a sound memo in Step S203. For example, the camera control unit 18 starts a series of operations to record a sound signal input from the sound input unit 25 on a recording medium as a sound file AF through the processing of the sound processing unit 26, the camera signal processing unit 13, and the recording control unit 14. For example, at this point, the camera control unit 18 starts processing to buffer sound data based on a sound input by the microphones 25L and 25R in the camera signal processing unit 13 for 60 seconds at a maximum.

The camera control unit 18 determines in Step S204 whether or not the assignable button 1100 is being pressed. In a case where the assignable button 1100 is being pressed, the camera control unit 18 determines in Step S205 whether or not a maximum recording time has elapsed.

In a case where it is determined that the maximum recording time has not elapsed, that is, in a case where the assignable button 110C is being pressed but the maximum recording time has not elapsed, the camera control unit 18 returns to the processing of Step S204.

On the other hand, in a case where it is determined in Step S204 that the assignable button 1100 is not being pressed or in a case where it is determined in Step S205 that the maximum recording time has elapsed, the camera control unit 18 performs recording stop control in Step S206. For example, the camera control unit 18 causes processing to buffer the sound signal input from the sound input unit 25 inside the camera signal processing unit 13 to be stopped through the processing of the sound processing unit 26.

Then, the camera control unit 18 causes processing to generate a sound file AF serving as a sound memo and store the same in a storage medium to be performed in Step S207. That is, the camera control unit 18 causes the camera signal processing unit 13 to perform compression processing, file format generation processing, or the like on buffered sound data and causes the recording control unit 14 to record data in a prescribed file data format (for example, a WAY file) on a recording medium.

In the manner described, the camera control unit 18 completes a series of the processing to record a sound memo shown in FIG. 29.

Thus, when the assignable button 110C is continued to be pressed, it is determined that the long-press of the assignable button 110C has occurred. As a result, sound memo recording processing is started. The sound memo recording processing is performed until the pressed state of the assignable button 1100 is cancelled or until a recording time reaches the maximum recording time.

When the recording time reaches the maximum recording time or when the long-pressed state of the assignable button 1100 is cancelled before the recording time reaches the maximum recording time, the recording of a sound memo is stopped.

After performing the recording stop processing, the camera control unit 18 generates a sound file AF serving as a sound memo corresponding to the recording processing and stores the same in the memory unit 19 in Step S207. After completing the processing of Step S207, the camera control unit 18 completes a series of the processing shown in FIG. 29.

That is, in a case where the series of the processing shown in FIG. 29 is performed as the processing of Step S113 in FIG. 27 is performed, the camera control unit 18 returns to the processing of Step S109 in FIG. 27.

Further, in a case where the series of the processing shown in FIG. 29 is performed as the processing of Step S113 in FIG. 28 is performed, the camera control unit 18 returns to the processing of Step S115 in FIG. 28.

In a case where it is determined in Step S202 that an operation to press the assignable button 110C for a short time has been performed, the camera control unit 18 determines in Step S208 whether or not a sound memo associated with an image that is being displayed on the display panel 101 exists. In a case where the associated sound memo does not exist, the camera control unit 18 completes the series of the processing shown in FIG. 29.

In a case where it is determined in Step S208 of FIG. 29 that the sound memo associated with the image exists, the camera control unit 18 performs control to start reproducing the sound memo in Step S209. For example, the camera control unit 18 instructs the recording control unit 14 to start reproducing a specific sound file AF and instructs the sound reproduction unit 27 to perform a reproduction operation.

During the reproduction of the sound memo, the camera control unit 18 determines in Step S210 whether or not the reproduction has been completed, determines in Step S211 whether or not an operation to complete the reproduction has been detected, and determines in Step S212 whether or not an operation to change a volume has been detected.

In a case where it is determined in Step S210 that the reproduction has been completed, that is, in a case where a reproduction output has reached the last of the sound data, the camera control unit 18 performs control to stop the reproduction with respect to the reproduction operations of the recording control unit 14 and the sound reproduction unit 27 to complete the series of the processing shown in FIG. 29 in Step S214.

Further, in a case where it is determined in Step S210 that the reproduction has not been completed, the camera control unit 18 determines in Step S211 whether or not the operation to complete the reproduction has been detected. In a case where the operation to complete the reproduction has been detected, the camera control unit 18 performs the control to stop the reproduction with respect to the reproduction operations of the recording control unit 14 and the sound reproduction unit 27 to complete the series of the processing shown in FIG. 29 in Step S214.

In addition, in a case where the operation to complete the reproduction has not been detected, the camera control unit 18 determines in Step S212 whether or not the operation to change a volume has been detected. In a case where the operation to change the volume has been detected, the camera control unit 18 performs control to change a reproduced volume with respect to the sound reproduction unit 27 in Step S213 and returns to the processing of Step S210. In a case where the operation to change a volume has not been detected, the camera control unit 18 returns to Step S210 without performing the processing of Step S213.

Note that although omitted in each of the figures, processing to stop the display of the display panel 101 is appropriately performed when an operation to turn off a power supply has been detected.

<6-3. Transfer Processing>

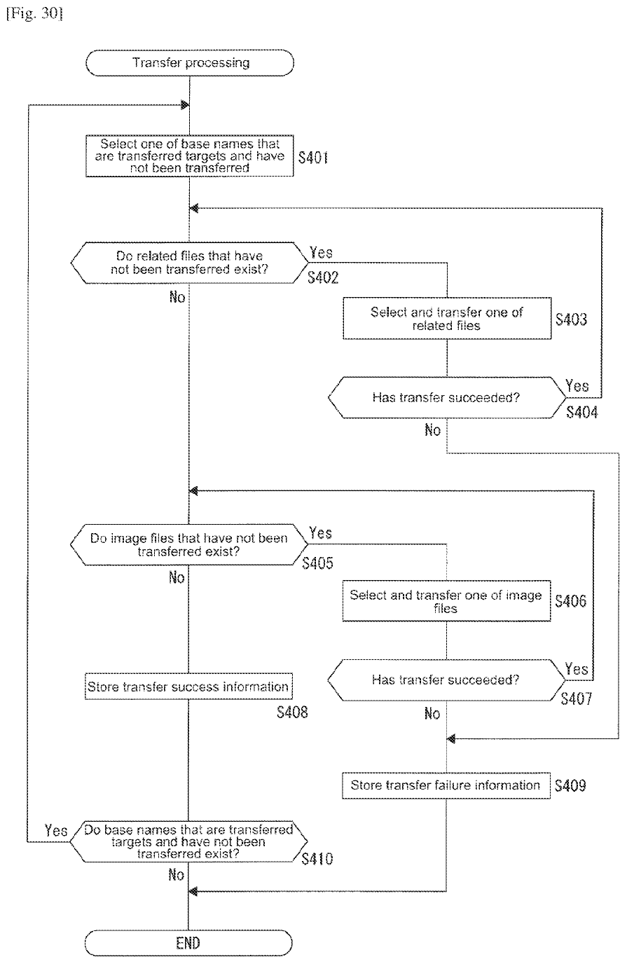

Processing performed by the camera control unit 18 to realize the processing to transfer a related file or the processing to transfer an image file PF shown in each of FIGS. 21 to 25 is shown in FIG. 30.

The camera control unit 18 of the imaging apparatus 1 that has detected an operation to start. FTP transfer by the user selects one of base names that are transferred targets and have not been transferred in Step S401.

The user selects any of images to be transferred when performing the operation to start the FTP transfer. In Step S401, the user performs processing to select one image from among selected images, that is, a file group including one or a plurality of image files PF and one or a plurality of related files.

Specifically, when the user selects the three images of base names “00001,” “00002,” and “00003” as transferred targets, he/she selects the one base name “00001” from among the images in the selection processing of Step S401. A file group linked with the base name “00001” contains a RAW file or a JPEG file serving as an image file PF, a sound file AF or a text file serving as a related file, or the like.

The camera control unit 18 determines in Step S402 whether or not related files that have not been transferred exist. In a case where the related files that have not been transferred exist, the camera control unit 18 performs processing to select one of the related files and transfers the related file in Step S403. Subsequently, the camera control unit 18 determines in Step S404 whether or not a transfer completion notification has been received. This processing is performed after the elapse of a prescribed time to determine, for example, the occurrence of a timeout. Further, in a case where the transfer completion notification has been received before the elapse of the prescribed time, the camera control unit 18 returns to the processing of Step S402 without waiting for the elapse of the prescribed time.

The camera control unit 18 performs processing to successively transfer related files by repeatedly performing each of the processing of Steps S402, S403, and S404 by the number of times corresponding to the number of the related files.

Further, in a case where the processing to transfer any of the related files fails, the camera control unit 18 proceeds to Step S409 that will be described later.

In a case where the processing to transfer all the related files is normally completed, the camera control unit 18 determines in Step S402 that related files that have not been transferred do not exist and proceeds to the processing of Step S405.

In the processing of Step S405, the camera control unit 18 determines whether or not image files PF that have not been transferred exist. Specifically, the camera control unit 18 determines the presence or absence of the image files PF that are transferred targets and have not been transferred. In a case where files that have not been transferred but are not transferred targets exist, that is, in a case where RAW files or the like exist in a case where only MEG files are set as transferred targets, such files are not handled as the image files PF that have not been transferred.

In a case where the image files PF that have not been transferred exist, the camera control unit 18 selects one of the image files PF and transfers the image file in Step S406. Subsequently, the camera control unit 18 determines in Step S407 whether or not a transfer completion notification has been received. This processing is performed after the elapse of a prescribed time to determine, for example, the occurrence of a timeout. Further, in a case where the transfer completion notification has been received before the elapse of the prescribed time, the camera control unit 18 returns to the processing of Step S405 without waiting for the elapse of the prescribed time.

The camera control unit 18 performs processing to successively transfer the image files PF by repeatedly performing each of the processing of Steps S405, S406, and S407 by the number of times corresponding to the number of the image files PF.

Further, in a case where the processing to transfer any of the image files PF fails the camera control unit 18 proceeds to Step S409 that will be described later.

In a case where the processing to transfer all the image files PF is normally completed, the camera control unit 18 determines in Step S405 that image files PF that have not been transferred do not exist and proceeds to the processing of Step S408.

The camera control unit 18 stores information showing “success” in the transfer status of the image file PF in Step S408, considering that the processing to transfer the image file PF having the base name selected in Step S401 as a file name has been normally completed.

On the other hand, in a case where it is determined that the processing to transfer a file has failed in one of the processing of Step S403 and the processing of Step S407, the camera control unit 18 stores information showing “failure” in the transfer status of the image file PP in Step S409, considering that the processing to transfer the image file PF having the base name selected in Step S401 as a file name has not been normally completed.

After storing the information in the transfer status in Step S408 or Step S409, the camera control unit 18 determines in Step S410 whether or not base names that are transferred targets and have not been transferred exist. For example, when the user has selected the three images of the base names “0001,” “0002,” and “0003” and when the camera control unit 18 performs the processing of Step S410 after the transfer of the file group of the base name “0001” has been completed as described above, the camera control unit 18 determines that the base names that are transferred targets and have not been selected exist. In this case, the camera control unit 18 returns to Step S401 and selects one of the base names “0002” and “0003” that have not been selected.

On the other hand, in a case where base names that are transferred targets and have not been transferred do not exist, that is, in a case where a file group related to base names designated as transmitted targets by the user has been entirely transferred, the camera control unit 18 completes a series of the processing shown in FIG. 30.

Note that in a case where the information showing “failure” is stored in the transfer status of the image file PF in Step S409, it is unlikely that processing to transfer other files is normally completed. Accordingly, after the processing of Step S409 is performed, the series of the processing shown in FIG. 30 may be completed even if other file groups related to base names that have not been transferred exist.

Further, although processing to transfer the file groups related to the base names that have not been selected in Step S401 is not performed at all in this case, the information showing “failure” may be stored in the transfer statuses of the file groups.

Further, in a case where the information showing “failure” is stored in the transfer status of the image file PF, the imaging apparatus 1 is capable of performing retransmission processing. For example, the re-transmission processing may be configured to be performed a plurality of times by a setting, or may be configured to be performed by the operation of the user.

Further, as the re-transmission processing, the series of the processing shown in FIG. 30 only has to be performed in order from Step S401. That is, since it is not possible to determine whether or not processing to transfer related files has failed from the information showing “failure” stored as a transfer status, all the processing including the processing to transfer the related files is performed. However, file groups of which the transfer status is “success” are not handled as transferred targets. For example, in a case where transferred targets designated by the user are the three images of the base names “0001,” “00002,” and “00003” and in a case where only the image of the base name “00003” is an image of which the transfer status is “failure” after the series of the processing shown in FIG. 30 is performed, a target to be subjected to the retransmission processing is only the file group of the base name“00003.”

<7. Summary>

As described in each of the examples, the imaging apparatus 1 includes a transmission control unit (the communication control unit 33) that, for transmitting (transferring) a file group including one image file PF and a related file associated with the one image file, performs second transmission processing (the processing of Step S406 in FIG. 30) to transmit the one image file PF in a case where first transmission processing (the processing of Step S403 in FIG. 30) to transmit a related file is normally completed.

Each of the above-mentioned examples shows transfer processing based on FTP as an example of transmission processing. However, a case where a file related to a captured image retained by the imaging apparatus 1 is transmitted (transferred) to other imaging apparatuses or other information processing apparatuses may also be assumed. That is, the transmission (transfer) of an image file PF is not performed in a case where the transmission of a related file fails.

Thus, for example, in a case where processing to transmit a related file fails due to the degradation of a communication environment, processing to transmit an image file PF that is highly likely to fail for the same reason is not performed, whereby it is possible to eliminate the necessity to perform waste processing and reduce burdens on the processing of the imaging apparatus 1 or reduce the exhaustion of a battery. Note that, for example, in a case where both a JPEG file and a RAW file are transmitted, a related file may be regarded as being linked with the JPEG file serving as one image file PF or may be regarded as being linked with the RAW file serving as one image file PF.

As described in each of the above-mentioned examples, the imaging apparatus 1 may include the status management unit 34 that stores second result information (the above-mentioned transfer status of an image file PF) on the second transmission processing without storing first result information regarding the first transmission processing (the processing of Step S403 in FIG. 30).

Thus, compared with a case where the results of both the first transmission processing and the second transmission processing are managed, the amount of managed statuses is reduced.

Thus, it is possible to simplify the management of transmission statuses and reduce burdens on the imaging apparatus 1. Further, it is possible to reduce the use area of a storage unit with a reduction in the amount of managed statuses.

As described with reference to FIG. 23, the status management unit 34 may store information showing transmission failure as second result information (the above-mentioned transfer status of an image file PF) in a case where the second transmission processing (the processing of Step S406 in FIG. 30) is not performed as a result of the failure of the first transmission processing (the processing of Step S403 in FIG. 30).

That is, even in a case where the transmission of an image file PF is not performed, the same status as that of a case where the transmission of the image file PF fails is set.

Thus, the same type of a transmission status is set even when an image file PF is not eventually transmitted. Therefore, it is possible to simplify the management of statuses and reduce burdens on the processing of the imaging apparatus 1.

As described with reference to FIG. 24, the transmission control unit (the communication control unit 33) may perform, even when a plurality of related files associated with one image file PF exists, the second transmission processing (the processing of Step S406 in FIG. 30) with respect to the one image file PP after performing the first transmission processing (the processing of Step S403 in FIG. 30) with respect to the plurality of related files.

Thus, an image file PF is transmitted at last among one file group.

Accordingly, the transmission of a plurality of related files is assumed to be successful in a case where the transmission of an image file PF is successful. Thus, it is possible to grasp the transmission results of a plurality of related files to a certain degree with the management of the transmission status of an image file PF.

As described with reference to FIG. 30, the transmission control unit (the communication control unit 33) is capable of performing re-transmission processing (the series of the processing shown in FIG. 30) in a case where second result information (the above-mentioned transfer status of an image file PF) shows failure. In the retransmission processing, the transmission control unit may perform both the first transmission processing (the processing of Step S403 in FIG. 30) with respect to a related file and the second transmission processing (the processing of Step S406 in FIG. 30) with respect to one image file PF.

Thus, both a related file and an image file PF are transmitted in the re-transmission processing.

For example, in a case where only processing to transmit a related file has succeeded, an information processing apparatus on a reception side stores only the related file not allowed to be linked with an image file PF since the image file PF has not been receivable. Since the related file not linked with the image file PF is meaningless, it is that the information processing apparatus on the reception side performs processing to delete the related file.

Even if only the image file PF is transmitted in the re-transmission processing in such a case, the related file has been deleted in the information processing apparatus on the reception side. That is, the related file is in a state of being lost in the information processing apparatus.

According to the present configuration, a related file and an image file PF are reliably linked with each other in an information processing apparatus on a reception side since both the related file and the image file PF are transmitted in the re-transmission processing. Thus, it is possible to eliminate the possibility of losing a related file in which information supporting an image file PF is stored and increase the efficiency of performing an editing operation on the received image file PF. Further, even if a related file is transmitted doubly in the re-transmission processing, it is not likely that a transmission time becomes excessively long since the related file is smaller in size than an image file PF. In addition, it is possible to reduce the wasteful consumption of resources used for the re-transmission processing compared with a case where an image file PP is transmitted doubly.

Note that although the above-mentioned example describes a case where a related file serving as a sound file AF is transmitted, the transmission of the sound file AF in a text form makes it possible to minimize the wasteful consumption of resources during re-transmission.

Further, the re-transmission processing may be performed by the operation of the user, may be automatically performed a prescribed number of times when transmission processing fails, or may be performed until a prescribed time elapses after the transmission processing fails.

As described above, an image file PF may be RAW data.

An image file PF serving as a transmitted target may be selectable, and RAW data may be provided as one of alternatives.

Thus, even in a case where RAW data is transmitted, the management of the transmission status of the RAW data makes it possible to estimate the possibility of transmitting a related file.

As described above, an image file PF may be an image file PF (for example, a JPEG file) other than RAW data.

An image file PP serving as a transmitted target may be selectable, and a file format such as JPEG and TIFF other than RAW data may be provided as one of alternatives.

Thus, the management of the transmission status of an image file PP such as JPEG and TIFF makes it possible to estimate the possibility of transmitting a related file.

As described in the section of FTP transfer, a related file may be a file associated with one image file PP when an image is captured.

For example, a related file includes a text file or the like generated to be linked with a captured image when the image is captured.

Thus, a related file generated and linked when an image is captured is also managed by the transmission status of an image file PF.

As described above, a related file may be a file associated with one image file PP when an image is reproduced.

For example, a related file includes a sound memo input when an image is reproduced, a text file obtained by converting the sound memo into a text form, or the like.

Thus, a file generated when an image is reproduced is linked as a related file, and its transmission result is managed by the transmission status of an image file PF.

As described above, a related file may be an image file PF of a thumbnail image of an image file PF.

For example, a thumbnail image generated after an image is captured may be a related file linked with an image file PF.

As described above, a related file may be a sound file or the like.

Further, a sound file generated as a sound memo or the like is also handled as a related file.

As described above, a related file may be a text file.

For example, a text file reduced in weight obtained by converting a sound memo into a text form may also be a related file. A generated text file or the like is also a related file.

The transmission results of such various related files are managed by the transmission statuses of associated image files PF with which the related files are linked. Accordingly, since there is no need to retain a transmission status for each related file, it is possible to reduce the amount of information regarding managed targets and facilitate the management of the information. Further, it is possible to reduce burdens on the processing of the imaging apparatus 1.

As described in the section of a file group, the file name of an image file PF and the file name of a related file may be different from each other only in an extension.

That is, the comparison of the character strings of portions excluding the extensions of file names makes it possible to determine whether or not the files are associated with each other.

Accordingly, since there is no need to generate a database or the like for specifying related files, it is possible to reduce burdens on the processing of the imaging apparatus 1 or reduce a storage area used in the imaging apparatus 1.

A program according to the embodiment is a program that causes, for example, a CPU, a DSP, or a device including these processors to perform each of the processing shown in FIG. 30.

That is, the program according to the embodiment causes a control unit such as the camera control unit 18 to perform the first transmission processing to transmit a related file associated with one image file.

Further, the program causes the control unit to perform the second transmission processing to transmit the one image file in a case where the first transmission processing succeeds.

The realization of the above-mentioned imaging apparatus 1 is made possible by such a program.

Such a program that realizes the imaging apparatus 1 may be recorded in advance on a HDD serving as a recording medium included in equipment such as a computer apparatus, a ROM inside a microcomputer having a CPU, or the like. Alternatively, such a program may be temporarily or permanently stored in (recorded on) a removable recording medium such as a flexible disk, a compact disc read-only memory (CD-ROM), a magneto optical (MO) disc, a digital versatile disc (DVD), a Blu-ray Disc™, a magnetic disc, a semiconductor memory, and a memory card. Such a removable recording medium may be offered as so-called package software.

Further, such a program may be downloaded from a download site via a network such as a local area network (LAN) and the Internet, besides being installed in a personal computer or the like from a removable recording medium.

Further, according to such a program, the imaging apparatus 1 of the embodiment is suitably offered in a wide range. For example, the program is downloaded in equipment having a camera function such as a mobile terminal apparatus like a smart phone or a tablet, a mobile phone, a personal computer, a video game console, video equipment, and a personal digital assistant (PDA). Thus, equipment such as the smart phone may be caused to function as the imaging apparatus 1 of the present disclosure.

Note that the effects described in the present specification are given for illustration and not limitative. Further, other effects may be produced.

<8. Present Technology>

(1)

An imaging apparatus including:

a transmission control unit that, for transmitting a file group including one image file and a related file associated with the one image file, performs second transmission processing to transmit the one image file in a case where first transmission processing to transmit the related file is normally completed.

(2)

The imaging apparatus according to (1), further including

a status management unit that stores second result information regarding the second transmission processing without storing first result information regarding the first transmission processing.

(3)

The imaging apparatus according to (1), in which

the status management unit stores information showing transmission failure as the second result information in a case where the second transmission processing is not performed as a result of failure of the first transmission processing.

(4)

The imaging apparatus according to any of (1) to (3), in which,

In a case where the related file associated with the one image file includes a plurality of related files, the transmission control unit performs the second transmission processing with respect to the one image file after performing the first transmission processing with respect to the plurality of related files.

(5)

The imaging apparatus according to (2) or (3), in which

the transmission control unit is capable of performing re-transmission processing in a case where the second result information shows failure, and performs both the first transmission processing with respect to the related file and the second transmission processing with respect to the one image file in the retransmission processing.

(6)

The imaging apparatus according to any of (1) to (5), in which

the image file includes RAW data.

(7)

The imaging apparatus according to any of (1) to (5), in which the image file includes an image file other than RAW data.

(8)

The imaging apparatus according to any of (1) to (7), in which

the related file includes a file associated with the one image file when an image is captured.

(9)

The imaging apparatus according to any of (1) to (7), in which

the related file includes a file associated with the one image file when an image is reproduced.

(10)

The imaging apparatus according to any of (1) to (9), in which

the related file includes an image file of a thumbnail image of the image file.

(11)

The imaging apparatus according to any of (1) to (9), in which

the related file includes a sound file.

(12)

The imaging apparatus according to any of (1) to (9), in which

the related file includes a text file.

(13)

The imaging apparatus according to any of (1) to (12), in which

a file name of the image file and a file name of the related file are different from each other only in an extension.

(14)

An information processing method in which an information processing apparatus performs:

first transmission processing to transmit a related file associated with one image file; and

second transmission processing to transmit the one image file, the second transmission processing being performed in a case where the first transmission processing succeeds.

(15)

A program causing an information processing apparatus to perform:

first transmission processing to transmit a related file associated with one image file; and

second transmission processing to transmit the one image file, the second transmission processing being performed in a case where the first transmission processing succeeds.

(1A)

An information processing device comprising:

a controller configured to transmit a file group including an image file and a related file associated with the image file, and perform second transmission processing to transmit the image file in a case where first transmission processing to transmit the related file is completed.

(2A)

The information processing device according to (1A), wherein the controller is configured to perform a status management processing that sets a completion indication regarding the second transmission processing.

(3A)

The information processing device according to (2A), wherein the completion indication is that the second transmission processing is completed.

(4A)

The information processing device according to (2A), wherein the completion indication is that the second transmission processing is failed.

(5A)

The information processing device according to (1A), wherein the controller is configured to perform a status management processing that stores a completion indication regarding the second transmission processing without storing another completion indication regarding the first transmission processing.

(6A)

The information processing device according to (1A), wherein the controller is configured to terminate the second transmission processing in a case where the first transmission processing to transmit the related file is failed.

(7A)

The information processing device according to (6A), wherein the first transmission processing to transmit the related file is determined as failed in a case where it is not completed after an elapse of a predetermined period of time.

(8A)

The information processing device according to (2A), wherein the status management processing sets the completion indication as failed in a case where the second transmission processing is not performed as a result of failure of the first transmission processing.

(9A)

The information processing device according to (1A), wherein,

In a case where the related file associated with the image file is one of a plurality of related files, the controller performs the second transmission processing with respect to the image file after performing the first transmission processing for the plurality of related files.

(10A)

The information processing device according to (2A), wherein

the controller is configured to perform re-transmission processing in a case where the completion indication is initially set as failed, and

perform both the first transmission processing with respect to the related file and the second transmission processing with respect to the image file in the re-transmission processing.

(11A)

The information processing device according to (1A), wherein the image file is contained in a RAW data file.

(12A)

The information processing device according to (1A), wherein the image file is contained in an image file other than a RAW data file.

(13A)

The information processing device according to (1A), wherein the related file is associated with the image file when an image corresponding to the image file is captured.

(14A)

The information processing device according to (1A), wherein the related file is associated with the image file when an image corresponding to the image file is reproduced.

(15A)

The information processing device according to (1A), wherein the related file comprises a thumbnail image of the image file.

(16A)

The information processing device according to (1A), wherein the related file comprises a sound file.

(17A)

The information processing device according to (1A), wherein the related file comprises a text file.

(18A)

The information processing device according to (1A), wherein an image file name of the image file and a related file name of the related file have a same base name and a different extension.

(19A)

An information processing method in which an information processing apparatus performs:

first transmission processing to transmit a related file associated with an image file; and

second transmission processing to transmit the image file, the second transmission processing being performed in a case where the first transmission processing is completed.

(20A)

A non-transitory computer readable medium storing program code for causing an information processing apparatus to perform operations comprising:

first transmission processing to transmit a related file associated with an image file; and

second transmission processing to transmit the image file, the second transmission processing being performed in a case where the first transmission processing is completed.

### REFERENCE SIGNS LIST

1 Imaging apparatus
33 Communication control unit
34 Status management unit
PF Image file
AF Sound file (related file)

1. An information processing device comprising:
a controller configured to transmit a file group including an image file and
a related file associated with the image file, and perform second transmission processing to transmit the image file in a case where first transmission processing to transmit the related file is completed.

2. The information processing device according to claim 1, wherein the controller is configured to perform a status management processing that sets a completion indication regarding the second transmission processing.

3. The information processing device according to claim 2, wherein the completion indication is that the second transmission processing is completed.

4. The information processing device according to claim 2, wherein the completion indication is that the second transmission processing is failed.

5. The information processing device according to claim 1, wherein the controller is configured to perform a status management processing that stores a completion indication regarding the second transmission processing without storing another completion indication regarding the first transmission processing.

6. The information processing device according to claim 1, wherein the controller is configured to terminate the second transmission processing in a case where the first transmission processing to transmit the related file is failed.

7. The information processing device according to claim 6, wherein the first transmission processing to transmit the related file is determined as failed in a case where it is not completed after an elapse of a predetermined period of time.

8. The information processing device according to claim 2, wherein the status management processing sets the completion indication as failed in a case where the second transmission processing is not performed as a result of failure of the first transmission processing.

9. The information processing device according to claim 1, wherein, in a case where the related file associated with the image file is one of a plurality of related files, the controller performs the second transmission processing with respect to the image file after performing the first transmission processing for the plurality of related files.

10. The information processing device according to claim 2, wherein the controller is configured to perform re-transmission processing in a case where the completion indication is initially set as failed, and perform both the first transmission processing with respect to the related file and the second transmission processing with respect to the image file in the re-transmission processing.

11. The information processing device according to claim 1, wherein the image file is contained in a RAW data file.

12. The information processing device according to claim 1, wherein the image file is contained in an image file other than a RAW data file.

13. The information processing device according to claim 1, wherein the related file is associated with the image file when an image corresponding to the image file is captured.

14. The information processing device according to claim 1, wherein the related file is associated with the image file when an image corresponding to the image file is reproduced.

15. The information processing device according to claim 1, wherein the related file comprises a thumbnail image of the image file.

16. The information processing device according to claim 1, wherein the related file comprises a sound file.

17. The information processing device according to claim 1, wherein the related file comprises a text file.

18. The information processing device according to claim 1, wherein an image file name of the image file and a related file name of the related file have a same base name and a different extension.

19. An information processing method in which an information processing apparatus performs:
first transmission processing to transmit a related file associated with an image file; and
second transmission processing to transmit the image file, the second transmission processing being performed in a case where the first transmission processing is completed.

20. A non-transitory computer readable medium storing program code for causing an information processing apparatus to perform operations comprising:
first transmission processing to transmit a related file associated with an image file; and
second transmission processing to transmit the image file, the second transmission processing being performed in a case where the first transmission processing is completed.
